(19) United States
(12) Patent Application Publication
(10) Pub. No.: US 2024/0373492 A1
(43) Pub. Date: Nov. 7, 2024

(54) METHOD AND APPARATUS FOR APPLYING CONFIGURATION OF CHILD NODE FOR MIGRATION IN BACKHAUL-ACCESS HOLE COMBINED SYSTEM

(71) Applicant: Samsung Electronics Co., Ltd., Gyeonggi-do (KR)

(72) Inventor: June HWANG, Gyeonggi-do (KR)

(21) Appl. No.: 18/572,303

(22) PCT Filed: Jun. 27, 2022
(86) PCT No.: PCT/KR2022/009121

§ 371 Date: Dec. 20, 2023

(30) Foreign Application Priority Data
Jun. 25, 2021 (KR) 10-2021-0083298
Jul. 15, 2021 (KR) 10-2021-0092903

(51) Int. Cl. H04W 76/20; H04W 74/0833

(52) U.S. Cl. CPC H04W 76/20; H04W 74/0833

(57) ABSTRACT

The present disclosure relates to a 5G or 6G communication system for supporting a higher data transmission rate. According to embodiments of the present disclosure, a method and apparatus for applying a configuration of a child node for migration in a backhaul-access hole combined system may be provided.

### TECHNICAL FIELD

The disclosure relates to a method and apparatus for applying a configuration of a child node for migration in a backhaul-access hole combined system.

In addition, the disclosure generally relates to a wireless communication system and, more particularly, relates to a method and apparatus for performing handover by using a conditional handover configuration in case that a backhaul and access hole combined node performs handover in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial state of 5G mobile communication technologies, in order to support services and to satisfy performance requirements in connection with enhanced Mobile BroadBand, (eMBB). Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In the case of migration of an integrated access and backhaul (TAB) node, child nodes of a migrating IAB node also need to receive new configuration information from a new donor node or donor distributed unit (DU). The migrating IAB node may receive, in advance, RRC and DU configuration information needed before migration, may apply the same at the time of migration, and may complete migration. However, in the case of the child nodes, it is unclear when DU configuration and RRC configuration information is to be delivered and when to apply the same although the information is received. In case that configuration information is requested and received from the new donor node or donor DU after the migration of the migration IAB node is completed, the child nodes may not perform an IAB operation while the request and reception is performed, and thus it is an interval in which interruption occurs from the perspective of a UE. This is to reduce the interruption.

In addition, based on the above-described discussion, the disclosure provides a method and apparatus for performing handover by using a conditional handover configuration in case that a backhaul and access hole combined node performs handover in a wireless communication system.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

According to an embodiment of the disclosure to solve the above-described drawback, there is provided a method of providing, to child nodes of a migrating IAB node in advance, pieces of configuration information to be applied after migration, and enabling application of the received configuration information at a predetermined point in time.

According to various embodiments of the disclosure, there is provided a method of operating a network node in a wireless communication system, and the method includes a process of receiving DU configuration information before conditional handover configuration information is received or handover is performed, and a process of applying the DU configuration information when conditional handover is performed.

According to various embodiments of the disclosure, there is provided an apparatus of a network node in a wireless communication system, and the apparatus may include a transceiver and at least one processor, and the at least one processor is configured to receive DU configuration information before conditional handover configuration information is received or handover is performed, and to apply the DU configuration information in case that conditional handover is performed.

In addition, a method performed by a base station of a communication system according to an embodiment of the disclosure to solve the above-described drawback may include receiving, from a donor base station, an indicator and a radio resource control (RRC) reconfiguration message including configuration information for at least one child node of the base station, wherein the indicator indicates, to the base station, withholding (storing) of the RRC reconfiguration message until a predetermined (previously configured) condition is met (satisfied); withholding the RRC reconfiguration message until the predetermined condition is met; and transmitting the RRC reconfiguration message to the at least one child node in case that the predetermined condition is met.

In addition, the predetermined condition may include at least one of the case in which a random access procedure is successfully completed in case that the base station is a migrating node, or the case in which a mobile termination (MT) of the base station receives the RRC reconfiguration message from a parent node in case that the base station is a child node of the migrating node.

In addition, the configuration information may include at least one of a transport network layer (TNL) address or routing mapping information.

In addition, the base station may be an integrated access and backhaul (IAB) node.

In addition, a method performed by a donor base station of a communication system according to an embodiment of the disclosure to solve the above-described drawback may include transmitting, to a child node, an indicator and a radio resource control (RRC) reconfiguration message including configuration information for at least one grandchild node of the child node of the donor base station, wherein the indicator indicates, to the child node, withholding of the RRC reconfiguration message until a predetermined condition is met; and performing data transmission or reception with the child node and the at least one grandchild node based on the configuration information, wherein, in case that the predetermined condition is met, the RRC reconfiguration message is transmitted from the child node to the at least one grandchild node.

In addition, the predetermined condition may include at least one of the case in which a random access procedure is successfully completed in case that the child node is a migrating node, or the case in which a mobile termination (MT) of the child node receives the RRC reconfiguration message from a parent node in case that the child node is a child node of the migrating node.

In addition, the child node may be an integrated access and backhaul (IAB) node.

In addition, a base station of a communication system according to an embodiment of the disclosure to solve the above-described drawback may include a transceiver, and a controller that is coupled with the transceiver and configured to receives, from a donor base station, an indicator and a radio resource control (RRC) reconfiguration message including configuration information for at least one child node of the base station, the indicator indicating, to the base station, withholding of the RRC reconfiguration message until a predetermined condition is met, withholding the RRC reconfiguration message until the predetermined condition is met, and transmits the RRC reconfiguration message to the at least one child node in case that the predetermined condition is met.

In addition, a donor base station of a communication system according to an embodiment of the disclosure to solve the above-described drawback may include a transceiver and a controller that is coupled with the transceiver and configured to transmits, to a child node, an indicator and a radio resource control (RRC) reconfiguration message including configuration information for at least one grandchild node of the child node of the donor base station, the indicator indicating, to the child node, withholding of the RRC reconfiguration message until a predetermined condition is met, and performs, based on the configuration information, data transmission or reception with the child node and the at least one grandchild node, and in case that the predetermined condition is met, the RRC reconfiguration message is transmitted from the child node to the at least one grandchild node.

### Advantageous Effects of Invention

According to an embodiment of the disclosure, child nodes may reduce a delay time spent in requesting/obtaining IAB node configuration information after performing migration, and may reduce a communication delay time of an access UE (terminal).

In addition, a method and apparatus according to various embodiments of the disclosure may perform handover by using a conditional handover configuration in case that a backhaul and access hole combined node performs handover in a wireless communication system.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1 is a diagram illustrating a structure of an LTE system according to an embodiment of the disclosure.

FIG. 2 is a diagram illustrating a radio protocol structure of an LTE system according to an embodiment of the disclosure.

FIG. 3 is a diagram illustrating a structure of a next generation mobile communication system according to an embodiment of the disclosure.

FIG. 4 is a diagram illustrating a radio protocol structure of a next generation mobile communication system according to an embodiment of the disclosure.

FIG. 5 is a block diagram illustrating a structure of a UE according to an embodiment of the disclosure.

FIG. 6 is a block diagram illustrating a structure of a base station according to an embodiment of the disclosure.

FIG. 7 is a flowchart illustrating application of a configuration of an IAB node that performs intra donor migration, which is a problematic situation desired to be overcome, according to an embodiment of the disclosure.

FIG. 8 is a diagram illustrating an embodiment of the case in which a DU withholds and transfers configuration information according to an embodiment of the disclosure.

FIG. 9 is a diagram illustrating operation performed in the case of failure of migration of a migrating node when a scheme in which a DU stores configuration information is applied, according to an embodiment of the disclosure.

FIG. 10 is a diagram illustrating an embodiment of the case in which an MT withholds configuration information and applies the configuration information at a predetermined case according to an embodiment of the disclosure.

FIG. 11 is a diagram illustrating an embodiment of failure of handover in the case in which an MT withholds configuration information and applies the configuration information at a predetermined case according to an embodiment of the disclosure.

FIG. 12A and FIG. 12B are diagrams illustrating a process of migration of an IAB node in a wireless communication system according to an embodiment of the disclosure.

FIGS. 13A and 13B are diagrams illustrating a process of receiving and applying DU and BAP configuration information after accessing a target parent node in the case in which conditional handover is applied to IAB migration in a wireless communication system according to an embodiment of the disclosure.

FIGS. 14A and 14B are diagrams illustrating a process of transferring DU and BAP configuration information via an RRC signal in the case in which conditional handover is applied to IAB migration in a wireless communication system according to an embodiment of the disclosure.

FIGS. 15A and 15B are diagrams illustrating a process of transferring DU and BAP configuration information via an F1AP signal in the case in which conditional handover is applied to IAB migration in a wireless communication system according to an embodiment of the disclosure.

FIG. 16 is a diagram illustrating a process of transferring RRCReconfiguration via an RRC signal in a wireless communication system according to an embodiment of the disclosure.

FIG. 17 is a diagram illustrating a process of transferring RRCReconfiguration via an F1-AP in a wireless communication system according to an embodiment of the disclosure.

### MODE FOR THE INVENTION

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used. In the following description of the disclosure, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB”. That is, a base station described as “eNB” may indicate “gNB”. In addition, the term “terminal” may refer to not only mobile phones, NB-IoT devices, sensors, but also other wireless communication devices.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings. In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used. For example, the term “terminal” as used in the following description may refer to an MAC entity in a terminal that exists in each of a master cell group (MCG) and a secondary cell group (SCG).

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto.

In particular, the disclosure may be applied to 3GPP NR (5th generation mobile communication standards). Furthermore, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB”. That is, a base station described as “eNB” may indicate “gNB”. In addition, the term “terminal” may refer to not only mobile phones, NB-IoT devices, sensors, but also other wireless communication devices.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB). IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (eNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like. According to some embodiments, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In order to satisfy different requirements of the respective services, different transmission/reception techniques and transmission/reception parameters may be used between the services. However, the above mMTC, URLLC, and eMBB are merely examples of different types of services, and service types to which the disclosure is applied are not limited to the above examples.

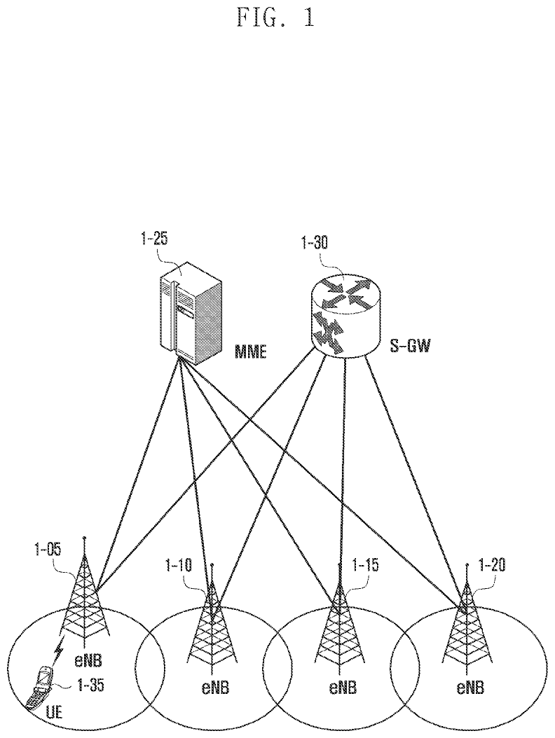

Furthermore, in the following description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure. FIG. 1 is a diagram illustrating the structure of an LTE system according to an embodiment of the disclosure.

Referring to FIG. 1, as illustrated in the drawing, a radio access network of an LTE system may include a next generation base station (an Evolved Node B (ENB), a Node B, or a base station) 1-05, 1-10, 1-15, and 1-20, a mobility management entity (MME) 1-25, and a serving-gateway (S-GW) 1-30. A user equipment (UE) (or a terminal) 1-35 accesses an external network via the ENB 1-05 to 1-20 and the S-GW 1-30.

In FIG. 1, the ENB 1-05, 1-10, 1-15, and 1-20 corresponds to a legacy node B in a UMTS system. The ENB 1-05, 1-10, 1-15, and 1-20 is connected to the UE 1-35 via a wireless channel and performs a more complex role than the legacy node B. In the LTE system, real-time services, such as a voice over IP (VoIP) based on an Internet protocol, and all user traffic may be provided via a shared channel. Therefore, there is a desire for a device that performs scheduling by collecting state information, such as the buffer states, available transmission power states, channel conditions, and the like associated with UEs 1-35, and the ENB 1-05, 1-10, 1-15, and 1-20 may be in charge of it. A single ENB 1-05, 1-10, 1-15, and 1-20 may generally control a plurality of cells. For example, in order to implement a transmission rate of 100 Mbps, the LTE system may use an orthogonal frequency division multiplexing (OFDM) as a wireless access technology in a bandwidth of 20 MHz. Furthermore, the ENB 1-05, 1-10, 1-15, and 1-20 may apply an adaptive modulation & coding (AMC) scheme that determines, based on the channel condition of the UE, a modulation scheme and a channel coding rate. The S-GW 1-30 is a device for providing a data bearer, and produces or removes a data bearer according to the control by the MME 1-25. The MME 1-25 is a device that is in charge of various types of control functions in addition to a mobility management function of the UE 1-35, and may be connected to the plurality of base stations 1-05, 1-10, 1-15, and 1-20.

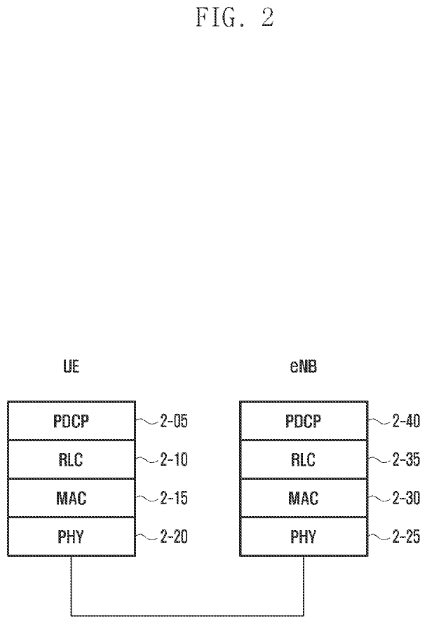

FIG. 2 is a diagram illustrating the radio protocol structure of an LTE system according to an embodiment of the disclosure.

Referring to FIG. 2, the radio protocol of the LTE system may include a packet data convergence protocol (PDCP) 2-05 and 2-40, a radio link control (RLC) 2-10 and 2-35, a medium access control (MAC) 2-15 and 2b-30, and a physical (PHY) device (or layer) 2-20 and 2-25 for each of a UE and an ENB. However, this is not limited to the above-described example, and may include fewer or more devices than the example.

According to an embodiment of the disclosure, a PDCP 2-05 and 2-40 may be in charge of operations such as IP header compression/decompression or the like. The main function of the PDCP may be summarized as follows. However, the function is not limited to the following example.
Header compression and decompression (Header compression and decompression: ROHC only):
Transfer of user data
Sequential delivery (In-sequence delivery of upper layer PDUs at PDCP re-establishment procedure for RLC AM (Acknowledged Mode))
Reordering (for split bearers in DC (only support for RLC AM): PDCP PDU routing for transmission and PDCP PDU reordering for reception)
Duplicate detection (Duplicate detection of lower layer SDUs at PDCP re-establishment procedure for RLC AM)
Retransmission (Retransmission of PDCP SDUs at handover and, for split bearers in DC, of PDCP PDUs at PDCP data-recovery procedure, for RLC AM)
Ciphering and deciphering
Timer-based SDU discard (Timer-based SDU discard in uplink)

According to an embodiment, a radio link control (RLC) 2-10 and 2-35 may reconfigure a PDCP packet data unit (PDU) to have an appropriate size and may perform an ARQ operation or the like. The main function of the RLC 2-10 and 2-35 may be summarized as follows. However, this is not limited to the following example.
Transfer of data (Transfer of upper layer PDUs)
ARQ (Error correction through ARQ (only for AM data transfer))
Concatenation, segmentation, and reassembly (Concatenation, segmentation and reassembly of RLC SDUs (only for UM and AM data transfer))
Re-segmentation (Re-segmentation of RLC data PDUs (only for AM data transfer))
Reordering (Reordering of RLC data PDUs (only for UM and AM data transfer)
Duplicate detection (Duplicate detection (only for UM and AM data transfer))
Error detection (Protocol error detection (only for AM data transfer))
RLC SDU discard (RLC SDU discard (only for UM and AM data transfer))
RLC re-establishment

According to an embodiment, the MAC 2-15 and 2-30 is connected with various RLC layer devices configured for a single UE, and multiplexes RLC PDUs to a MAC PDU and demultiplexes RLC PDUs from a MAC PDU. The main function of the MAC 2-15 and 2-30 may be summarized as follows. However, this is not limited to the following example.
Mapping (Mapping between logical channels and transport channels)
Multiplexing and demultiplexing (Multiplexing/demultiplexing of MAC SDUs belonging to one or different logical channels into/from transport blocks (TB) delivered to/from the physical layer on transport channels)
Scheduling information reporting
HARQ (Error correcting through HARQ)
Priority handling between logical channels (priority handling between logical channels of one UE)
Priority handling between UEs (Priority handling between UEs by means of dynamic scheduling)
MBMS service identification
Transport format selection
Padding

According to an embodiment, the PHY layer 2-20 and 2-25 performs an operation of channel-coding and modulating higher layer data to produce an OFDM symbol and transmitting the OFDM symbol via a wireless channel, or demodulating and channel-decoding an OFDM symbol received via a wireless channel and transferring the same to a higher layer. However, this is not limited to the above-described example.

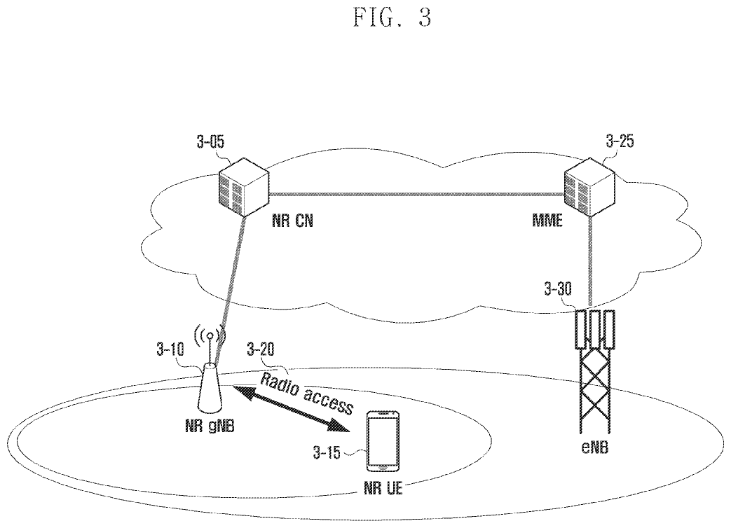

FIG. 3 is a diagram illustrating the structure of a next generation mobile communication system according to an embodiment of the disclosure.

Referring to FIG. 3, a radio access network of a next generation mobile communication system (hereinafter, NR or 5g) may include a next generation base station (new radio node B (hereinafter, an NR gNB or an NR base station)) 3-10 and a next generation radio core network (new radio core network (NR CN)) 3-05. A next generation radio user equipment (new radio user equipment (NR UE) (or a UE)) 3-15 may access an external network via an NR gNB 3-10 and an NR CN 3-05.

In FIG. 3, the NR gNB 3-10 corresponds to an Evolved Node B (eNB) of a legacy LTE system. The NR gNB 3-10 is connected to the NR UE 3-15 via a wireless channel, and may provide a better service than a service from the legacy Node B. In the next generation mobile communication system, all user traffic may be serviced via a shared channel. Accordingly, there is a desire for a device that performs scheduling by collecting state information such as the buffer states, available transmission power states, channel conditions, and the like in association with UEs 3-15, and the NR NB 3-10 may be in charge of the same. A single NR gNB 3-10 may control a plurality of cells. In order to implement ultra-high speed data transmission when compared to the current LTE, a bandwidth greater than or equal to the current maximum bandwidth may be applied in the next generation mobile communication system. In addition, an orthogonal frequency division multiplexing (OFDM) may be used as a radio access technology and a beamforming technology may be additionally used.

In addition, according to some embodiments, the NR gNB 3-10 may apply an adaptive modulation & coding (AMC) scheme that determines a modulation scheme and a channel coding rate based on the channel condition of the UE 3-15. The NR CN 3-05 may perform a function of supporting mobility, configuring a bearer, configuring a QoS, and the like. The NR CN 3-05 is a device that is in charge of various control functions in addition to a mobility management function associated with the UE 3-15, and may be connected to a plurality of base stations 3-10. In addition, the next generation mobile communication system may also interoperate with a legacy LTE system, and an NR CN 3-05 may be connected to an MME 3-25 via a network interface. The MME 3-25 may be connected to an eNB 3-30 which is a legacy base station.

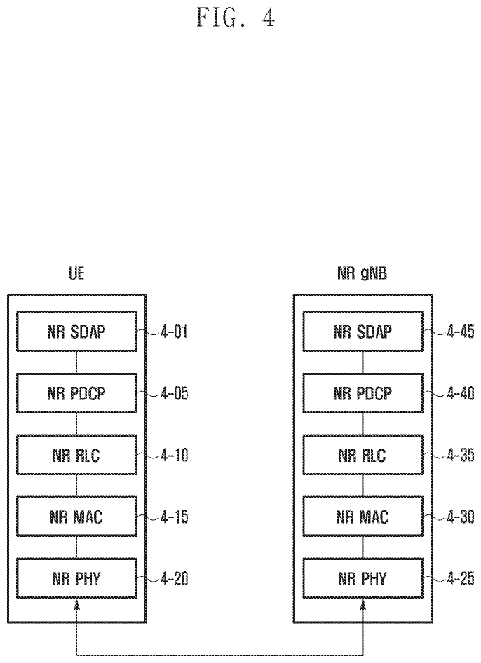

FIG. 4 is a diagram illustrating the radio protocol structure of a next generation mobile communication system according to an embodiment of the disclosure.

Referring to FIG. 4, the radio protocol of the next generation mobile communication system may include an NR service data adaptation protocol (SDAP) 4-01 and 4-45, an NR PDCP 4-05 and 4-40, an NR RLC 4-10 and 4-35, an NR MAC 4-15 and 4-30, and an NR PHY 4-20 and 4-25 devices (or layers) for each of a UE and an NR gNB. However, this is not limited to the above-described example and may include fewer or more devices than the example.

According to an embodiment, the main functions of the NR SDAP 4-01 and 4-45 may include some of the following functions. However, this is not limited to the following example.
Transfer of user data (transfer of user plane data)
Mapping between a QoS flow and a data bearer for both an uplink and a downlink (mapping between a QoS flow and a DRB for both DL and UL)
Marking a QoS flow ID in both a DL and an UL (marking QoS flow ID in both DL and UL packets)
Mapping a reflective QoS flow to a data bearer for uplink SDAP PDUs (reflective QoS flow to DRB mapping for the UL SDAP PDUs)

In association with an SDAP layer device, whether to use the header of the SDAP layer device or whether to use the function of the SDAP layer device may be configured for the UE via a radio resource control (RRC) message for each PDCP layer device, for each bearer, or for each logical channel. If the SDAP header is configured, the SDAP layer device may provide an indication using a non-access stratum (NAS) reflective quality of service (QoS) configuration one-bit indicator and an access stratum (AS) reflective QoS configuration one-bit indicator of the SDAP header so that the UE updates or reconfigures mapping information between a QoS flow and a data bearer in an uplink and a downlink. According to some embodiments, the SDAP header may include QoS flow ID information indicating a QoS. According to some embodiments, the QoS information may be may be used as data processing priority, scheduling information, or the like for supporting a smooth service.

According to an embodiment, the main functions of the NR PDCP 4-05 and 4-40 may include some of the following functions. However, this is not limited to the following example.
Header compression and decompression (Header compression and decompression: ROHC only)
Transfer of user data
Sequential delivery (In-sequence-delivery of upper layer PDUs)
Non-sequential delivery (Out-of-sequence delivery of upper layer PDUs)
Reordering (PDCP PDU reordering for reception)
Duplicate detection (Duplicate detection of lower layer SDUs)
Retransmission (Retransmission of PDCP SDUs)
Ciphering and deciphering
Timer-based SDU discard (Timer-based SDU discard in uplink)

In the above-description, the reordering function of the NR PDCP device is a function of sequentially reordering PDCP PDUs received from a lower layer according to a PDCP sequence number (SN). The reordering function of the NR PDCP device may include a function of transferring sequentially reordered data to a higher layer, a function of immediately transferring data irrespective of a sequence, a function of recording lost PDCP PDUs after sequential recording, a function of reporting the states of lost PDCP PDUs to a transmission side, and a function of requesting retransmission of lost PDCP PDUs.

According to some embodiments, the main functions of the NR RLC 4-10 and 4-35 may include some of the following functions. However, this is not limited to the following example.
Transfer of data (Transfer of upper layer PDUs)
Sequential delivery (In-sequence-delivery of upper layer PDUs)
Non-sequential delivery (Out-of-sequence delivery of upper layer PDUs)
ARQ (Error correcting through ARQ)
Concatenation, segmentation, and reassembly (Concatenation, segmentation and reassembly of RLC SDUs)
Re-segmentation (Re-segmentation of RLC data PDUs)
Reordering (Reordering of RLC data PDUs)
Duplicate detection
Error detection (Protocol error detection)
RLC SDU discard
RLC re-establishment

In the above-description, the in-sequence delivery function of the NR RLC device is a function of sequentially transferring RLC SDUs, received from a lower layer, to a higher layer. If a single original RLC SDU is divided into multiple RLC SDUs and the multiple RLC SUDs are received, the in-sequence delivery function of the NR RLC device may include a function of reassembling and transferring the same.

The in-sequence delivery function of the NR RLC device may include a function of reordering received RLC PDUs according to an RLC sequence number (SN) or a PDCP sequence number (SN), a function of recording lost RLC PDUs after sequential reordering, a function of reporting the states of the lost RLC PDUs to a transmission side, and a function of requesting retransmission of the lost RLC PDUs.

The in-sequence delivery function of the NR RLC device may include a function of sequentially transferring, to a higher layer, only RLC SDUs before a lost RLC SDU in case that a lost RLC SDU is present.

The in-sequence delivery function of the NR RLC device may include a function of sequentially transferring all RLC SDUs, received before a predetermined timer starts, to a higher layer even though a lost RLC SDU is present, in case that the predetermined timer expires.

The in-sequence delivery function of the NR RLC device may include a function of sequentially transferring all RLC SDUs, received up to the present, to a higher layer even though a lost RLC SDU exists, in case that a predetermined timer expires.

The NR RLC device may process RLC PDUs in order of reception, irrespective of a sequence number (out-of-sequence delivery), and may transfer the same to the NR PDCP device.

In the case in which the NR RLC device receives a segment, the NR RLC device receives segments, which are stored in a buffer or which are to be received in the future, reconfigures the segments as a single intact RLC PDU, and transmits the same to the NR PDCP device.

The NR RLC layer may not include a concatenation function, and the concatenation function may be performed in the NR MAC layer or may be replaced with a multiplexing function in the NR MAC layer.

In the above-description, the out-of-sequence delivery function of the NR RLC device is a function of transferring RLC SDUs, received from a lower layer, to a higher layer, irrespective of a sequence. In the case in which a single original RLC SDU is divided into multiple RLC SDUs and the multiple RLC SDUs are received, the out-of-sequence delivery function of the NR RLC device may include a function of reassembling and transmitting the same. The out-of-sequence delivery function of the NR RLC device may include a function of storing the RLC SN or PDCP SN of received RLC PDUs, sequentially ordering the same, and recording lost RLC PDUs.

According to some embodiments, the NR MAC 4-15 and 4-30 may be connected to multiple NR RLC layer devices configured for a single UE, and the main functions of the NR MAC may include some of the following functions. However, this is not limited to the following example.
Mapping (Mapping between logical channels and transport channels)
Multiplexing and demultiplexing (Multiplexing/demultiplexing of MAC SDUs)
Scheduling information reporting
HARQ (Error correcting through HARQ)
Priority handling between logical channels (priority handling between logical channels of one UE)
Priority handling between UEs (Priority handling between UEs by means of dynamic scheduling)
MBMS service identification
Transport format selection
Padding

The NR PHY layer 4-20 and 4-25 performs channel-coding and modulating of higher layer data to produce an OFDM symbol and transmits the OFDM symbol via a wireless channel, or performs demodulating and channel-decoding of an OFDM symbol received via a wireless channel and transmits the demodulated and channel-decoded OFDM symbol to a higher layer. However, this is not limited to the following example.

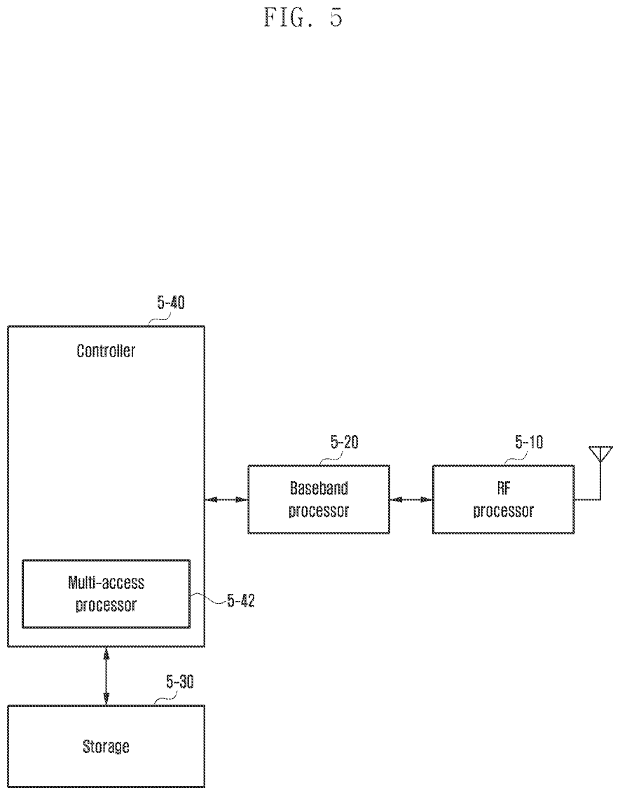

FIG. 5 is a block diagram illustrating the internal structure of a UE according to an embodiment of the disclosure.

Referring to FIG. 5, the UE may include a radio frequency (RF) processor 5-10, a baseband processor 5-20, a storage 5-30, and a controller 5-40. In addition, the controller 5-40 may further include a multi-access processor 5-42. However, this is not limited to the example, and may include a fewer or more number of component elements than the configuration of FIG. 5.

The RF processor 5-10 may perform a function of transmitting or receiving a signal via a wireless channel, such as band conversion and amplification of a signal. That is, the RF processor 5-10 up-converts a baseband signal provided from the baseband processor 5-20 into an RF band signal, transmits the RF band signal via an antenna, and down-converts an RF band signal received via the antenna into a baseband signal. For example, the RF processor 5-10 may include a transmission filter, a reception filter, an amplifier, a mixer, an oscillator, a digital-to-analog converter (DAC), an analog-to-digital converter (ADC), and the like. However, this is not limited to the above-described example. Although FIG. 5 illustrates only a single antenna, the UE may have a plurality of antennas. In addition, the RF processor 5-10 may include a plurality of RF chains. Furthermore, the RF processor 5-10 may perform beamforming. For the beamforming, the RF processor 5-10 may control the phase and the size of each signal transmitted or received via a plurality of antennas or antenna elements.

In addition, the RF processor 5-10 may perform multi-input multi-output (MIMO), and may receive multiple layers when performing a MIMO operation.

The baseband processor 5-20 performs a function for conversion between a baseband signal and a bit string according to the physical layer standard of the system. For example, when data is transmitted, the baseband processor 5-20 encodes and modulates a transmission bit string, so as to produce complex symbols. In addition, in the case of data reception, the baseband processor 5-20, restores a reception bit string by demodulating and decoding a baseband signal provided from the RF processor 5-10. For example, according to an orthogonal frequency division multiplexing (OFDM) scheme, in the case of data transmission, the baseband processor 5-20 produces complex symbols by encoding and modulating a transmission bit string, maps the complex symbols to subcarriers, and then configures OFDM symbols via an inverse fast Fourier transform (IFFT) operation and cyclic prefix (CP) insertion. In addition, in the case of data reception, the baseband processor 5-20 divides the baseband signal provided from the RF processor 5-10 in units of OFDM symbols, reconstructs the signals mapped to the subcarriers via a fast Fourier transform (FFT) operation, and then reconstructs a received bit string via demodulation and decoding.

The baseband processor 5-20 and the RF processor 5-10 transmit and receive signals as described above. Accordingly, the baseband processor 5-20 and the RF processor 5-10 may be referred to as a transmitter, a receiver, a transceiver, a communication unit, or a wireless communication unit, or the like. Furthermore, at least one of the baseband processor 5-20 and the RF processor 5-10 may include a plurality of communication modules in order to support a plurality of different radio access technologies. In addition, at least one of the baseband processor 5-20 and the RF processor 5-10 may include different communication modules to process signals of different frequency bands. For example, the different radio access technologies may include a wireless LAN (e.g., IEEE 802.11), a cellular network (e.g., LTE), and the like. Furthermore, the different frequency bands may include a super high frequency (SHF) (e.g., 2.NRHz, NRhz) band and a millimeter (mm) wave (e.g., 60 GHz) band. The UE may perform signal transmission or reception with a base station using the baseband processor 5-20 and the RF processor 5-10, and the signal may include control information and data.

The storage unit 5-30 may store data, such as a basic program, an application program, configuration information, and the like for operating a UE. Particularly, the storage 5-30 may store information related to a second access node that performs wireless communication using a second radio access technology. The storage 5-30 may provide data stored therein by request of the controller 5-40. The storage 5-30 may be embodied as a storage medium such as ROM, RAM, hard disk, CD-ROM, DVD, and the like, or a combination of storage media. In addition, the storage 5-30 may include a plurality of memories.

The controller 5-40 may control the overall operations of a UE. For example, the controller 5-40 may perform transmission or reception of a signal via the baseband processor 5-20 and the RF processor 5-10. In addition, the controller 5-40 may record data in the storage 5-40 and read the data. To this end, the controller 5-40 may include at least one processor. For example, the controller 5-40 may include a communication processor (CP) that performs control for communication, and an application processor (AP) that controls a higher layer such as an application program or the like. In addition, at least one component included in the UE may be embodied as a single chip. According to an embodiment of the disclosure, the controller 5-40 may control each component of a UE in order to transmit or receive control information in an IAB system. An operation method of a UE according to an embodiment of the disclosure will be described in detail below.

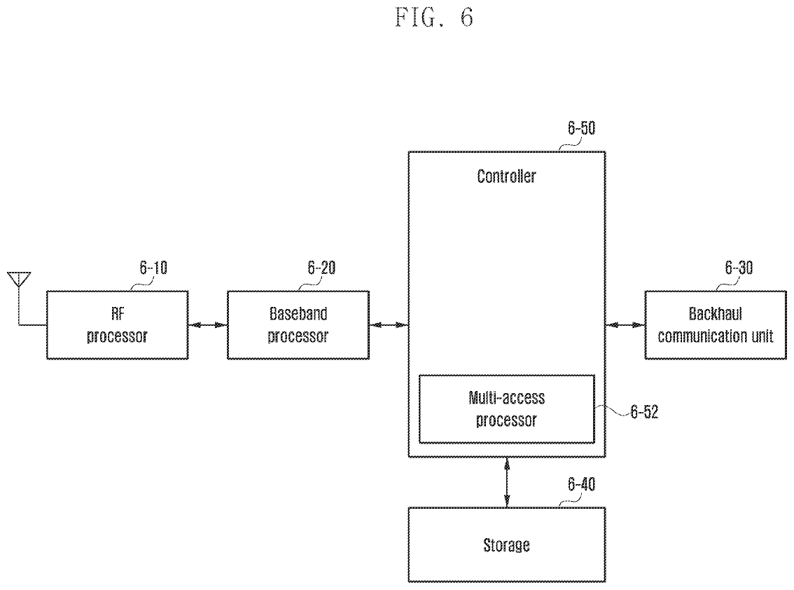

FIG. 6 is a block diagram illustrating the configuration of a base station according to an embodiment of the disclosure.

Referring to FIG. 6, the base station may include an RF processor 6-10, a baseband processor 6-20, a backhaul communication unit 6-30, a storage unit 6-40, and a controller 6-50. In addition, the controller 6-50 may further include a multi-access processor 6-52. However, this is not limited to the example, and may include a fewer or more number of components than the configuration of FIG. 6.

The RF processor 6-10 may perform a function of transmitting or receiving a signal via a wireless channel, such as band conversion and amplification of a signal. That is, the RF processor 6-10 up-converts a baseband signal provided from the baseband processor 6-20 into an RF band signal, transmits the RF band signal via an antenna, and then down-converts the RF band signal received via the antenna into a baseband signal. For example, the RF processor 6-10 may include a transmission filter, a reception filter, an amplifier, a mixer, an oscillator, a DAC, an ADC, and the like. Although FIG. 6 illustrates a single antenna, the RF processor 6-10 may include a plurality of antennas. In addition, the RF processor 6-10 may include a plurality of RF chains. Moreover, the RF processor 6-10 may perform beamforming. For the beamforming, the RF processor 6-10 may control the phase and the size of each signal transmitted or received via a plurality of antennas or antenna elements. The RF processor 6-10 may perform a downlink MIMO operation by transmitting one or more layers.

The baseband processor 6-20 may perform a function for conversion between a baseband signal and a bit string according to the physical layer standard of a first radio access technology. For example, in the case of data transmission, the baseband processor 6-20 encodes and modulates a transmission bit string, so as to produce complex symbols. In addition, in the case of data reception, the baseband processor 6-20, restores a reception bit string by demodulating and decoding a baseband signal provided from the RF processor 6-10. For example, according to the OFDM scheme, in the case of data transmission, the baseband processor 6-20 produces complex symbols by encoding and modulating a transmission bit string, maps the complex symbols to subcarriers, and then configures OFDM symbols via an IFFT operation and CP insertion. Furthermore, in the case of data reception, the baseband processor 6-20 may divide a baseband signal provided from the RF processor 6-10 in units of OFDM symbols, may reconstruct the signals mapped to the subcarriers via a FFT operation, and then may reconstruct a received bit string via demodulation and decoding. The baseband processor 6-20 and the RF processor 6-10 transmit and receive signals as described above. Accordingly, the baseband processor 6-20 and the RF processor 6-10 may be referred to as a transmitter, a receiver, a transceiver, a communication unit, a wireless communication unit, or the like. The base station may perform signal transmission or reception with a UE using the baseband processor 6-20 and the RF processor 6-10, and the signal may include control information and data.

The backhaul communication unit 6-30 may provide an interface for performing communication with other nodes in a network. That is, the backhaul communication unit 6-30 may convert, into a physical signal, a bit string transmitted from the base station to another node, for example, a secondary base station, a primary base station, another base station, a core network, and the like, and may convert a physical signal received from the other node into a bit string. The backhaul communication unit 6-30 may be included in a communication unit. The storage unit 6-40 may store data, such as a basic program for operating a base station, an application program, configuration information, and the like. The storage 6-40 may store information associated with a bearer allocated to a connected UE, a measurement result reported from a connected UE, and the like. In addition, the storage 6-40 may store information which is a criterion for determining whether to provide multiple accesses to a UE or to suspend the same. The storage 6-40 may provide data stored therein in response to a request from the controller 6-50. The storage 6-40 may be embodied as a storage medium such as ROM, RAM, a hard disk, a CD-ROM, a DVD, and the like, or a combination of storage media. In addition, the storage 6-40 may include a plurality of memories. According to some embodiments, the storage 6-40 may store a program for implementing a buffer state reporting method according to the disclosure.

The controller 6-50 controls the overall operations of the base station. For example, the controller 6-50 may transmit or receive a signal via the baseband processor 6-20 and the RF processor 6-10, or via the backhaul communication unit 6-30. In addition, the controller 6-50 may record data in the storage 6-40 and read the data. To this end, the controller 6-50 may include at least one processor. In addition, at least one component included in the base station may be embodied as a single chip.

According to an embodiment of the disclosure, the controller 6-50 may control each component of a base station in order to transmit or receive control information in an IAB system according to an embodiment of the disclosure. An operation method of a base station according to an embodiment of the disclosure will be described in detail below.

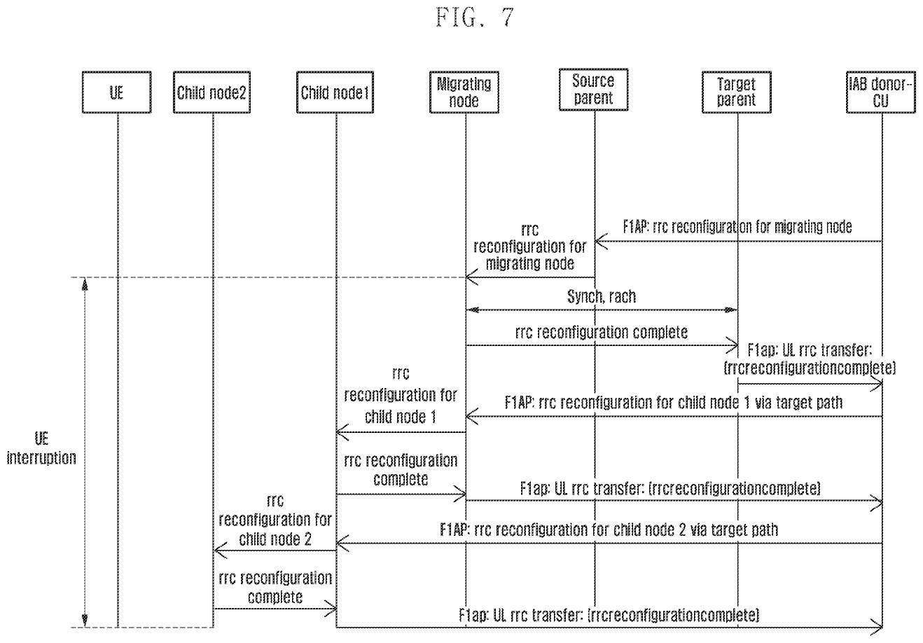

FIG. 7 is a flowchart illustrating application of a configuration of an IAB node that performs intra donor migration, which is a problematic situation desired to be overcome, according to an embodiment of the disclosure.

Referring to FIG. 7, a migrating node receives, from a donor centralized unit (CU), RRC configuration information and distributed unit (DU) configuration information that takes into consideration a target path and a change of a DU. In this instance, the corresponding DU configuration, for example, Internet protocol (IP) address information or new transport network layer (TNL) information to be applied to a DU after migration may be included in an RRC reconfiguration message. The migrating (IAB) node receives the RRC reconfiguration message, and applies the same and, at the same time, performs migration to a target parent. The migrating IAB node may transmit a migration complete message, that is, an RRCReconfigurationComplete message, to a target parent node. An IAB donor CU that receives the RRCReconfigurationComplete message from the target parent node includes the DU and RRC configuration information that takes into consideration the changed path and the changed donor DU in RRCReconfiguration and transmits the same to child node 1 of the corresponding migrating IAB node via the migrating TAB node. The child node 1 that receives the message may apply the corresponding RRCReconfiguration message and may transfer a complete message to the donor CU. In this instance, transferring according to an embodiment may be performed via the migrating node. The donor CU includes the DU and RRC configuration information that takes into consideration the changed path and donor DU in RRCReconfiguration and transfers, via child node 1, the same to child node 2 that is a child node of child node 1. Child node 2 that receives the message may apply the corresponding RRCReconfiguration message and may transfer a complete message to the donor CU. In this instance, transferring according to an embodiment may be performed via child node 1. In the process, an access UE of child node 2 may be incapable of receiving DL data traffic from a core network from the point in time at which the migrating node receives RRCReconfiguration. In addition, it may be incapable of receiving UL and DL until child node 2 that is its TAB node completes the whole configuration.

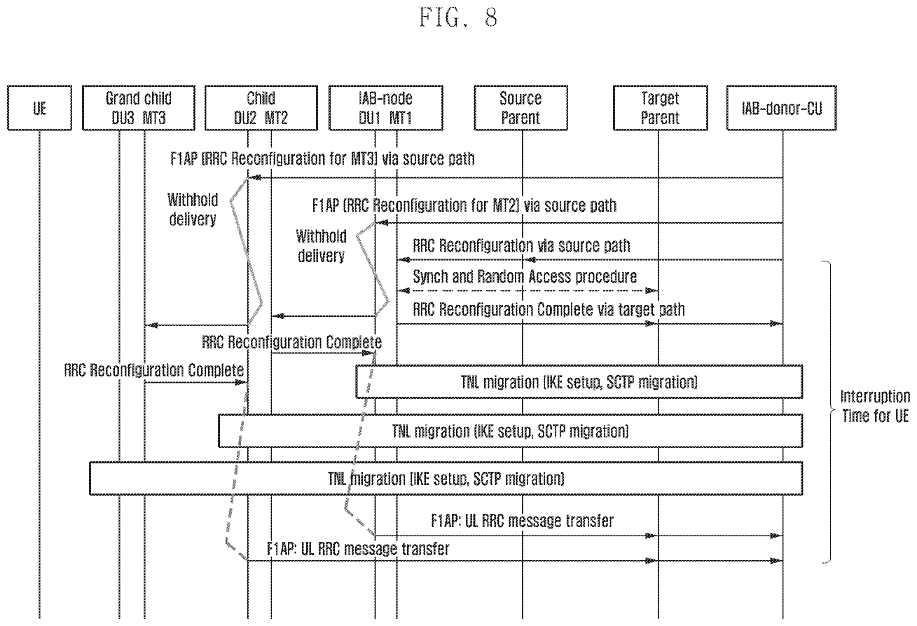

FIG. 8 is a diagram illustrating an embodiment of the case in which a DU withholds and transfers configuration information according to an embodiment of the disclosure.

Referring to FIG. 8, in the case in which a donor CU transfers, to a child node, an RRCReconfiguration message that stores DU and RRC configuration information, a DU of a parent node of a target child node withholds the corresponding RRCReconfiguration message and transfers the same to the target child node at a predetermined point in time.

The donor CU takes into consideration the topology of a migrating node and identifies whether the corresponding node has a child node. In case that a child node is present, the donor CU transfers (transmits) configuration information that takes into consideration a target path of the migrating node to each child node before transferring (transmitting) a handover command to the migrating IAB node. In case that the DU is connected to a new target donor or a new donor DU, new transport network layer (TNL) address information to be used, IP addresses to be allocated to the DU, and pieces of other configuration information of the DU may be transferred as the information. The information may be as follows.

Backhaul adaptation protocol (BAP) mapping configuration: routing mapping information used in the BAP of a corresponding IAB node, which may add or remove the following information.

>>BAP Routing ID
>>Next-Hop BAP Address

gNB-DU Resource Configuration: scheduling configuration information of a cell operated by a DU and scheduling configuration information of a cell operated by a child node, which may add/mod/release the following information.

```
Activated Cells to Be Updated List
  >Activated Cells To Be Updated List Item
    >> NR CGI
    >>CHOICE IAB-DU Cell Resource Configuration-Mode-Info
      >>>TDD
        >>>>TDD Info
          >>>>>gNB-DU Cell Resource Configuration-TDD
      >>>FDD
        >>>>FDD Info
          >>>>>gNB-DU Cell Resource Configuration-FDD-UL
          >>>>>gNB-DU Cell Resource Configuration-FDD-DL
Child-Nodes List
  >Child-Nodes List Item
    >>gNB-CU UE F1AP ID
    >>gNB-DU UE F1AP ID
    >>Child-Node Cells List
      >>>Child-Node Cells List Item
        >>>>NR CGI
        >>>>CHOICE IAB-DU Cell Resource Configuration Mode-Info
          >>>>>TDD
            >>>>>>TDD Info
              >>>>>>>gNB-DU Cell Resource Configuration-TDD
          >>>>>FDD
            >>>>>>FDD Info
              >>>>>>>gNB-DU Cell Resource Configuration-FDD-UL
              >>>>>>> gNB-DU Cell Resource
              Configuration-FDD-DL
        >>>>IAB STC Info
        >>>>RACH Config Common
        >>>>RACH Config Common IAB
        >>>>CSI-RS Configuration
        >>>>SR Configuration
        >>>>PDCCH Configuration SIB1
        >>>>SCS Common
        >>>>Multiplexing Info
```

IAB TNL Address Allocation: TNL address information that a CU requests a DU to allocate, and transfers an IP address and a prefix. The information may add/mod/release the following information.

```
IAB IPv4 Addresses Requested
CHOICE IAB IPv6 Request Type
  >IPv6 Address
    >>IAB IPv6 Addresses Requested
  >IPv6 Prefix
    >>IAB IPv6 Address Prefixes Requested
IAB TNL Addresses To Remove List
  >IAB TNL Addresses To Remove Item
    >>IAB TNL Address
```

Although the pieces of information have been transmitted via an F1-AP message, the information may be included in an RRCReconfiguration message and may be transmitted. According to an embodiment, the F1-AP message may be added to an RRCReconfiguration message and may be transmitted.

The donor CU may determine migration of the migrating IAB node, and may transfer, to descendant nodes (i.e., a child, a child of the child, or the like) of the migrating node, an RRCReconfiguration message including (the above-mentioned) information to be newly configured in association with the donor DU in a corresponding target path. In this instance, the RRCReconfiguration message is transmitted before migration by considering a migrating operation as a start point and thus, the RRCReconfiguration message may be transferred using a source path.

In case that the donor CU transfers (transmits) the RRCReconfiguration message to a descendant TAB node which is a target, the donor CU may include the RRCReconfiguration message in an F1AP message and may transfer the same to a DU part of a parent IAB node of the target descendant node. In this instance, in the F1AP message, the target descendant node is indicated as a destination.

In case that the DU transfers the message, the F1AP message may include an indicator. The indicator may indicate that the DU stores (withholds) or buffers, in advance, the received RRCReconfiguration message, and, when a predetermined event occurs, transfers (transmits) the same via a wireless signal to an IAB mobile termination (MT) that has been indicated as a transfer target, that is, a target descendant node. In addition, the F1AP message may include a unique identifier (id) capable of identifying the received RRCReconfiguration message. The id may be an RRC transaction id used for the corresponding RRCReconfiguration message, or an integer value that the donor CU arbitrarily defines may be an id. In case that the DU stores a plurality of RRCReconfiguration messages for the corresponding target descendant node, the version of each RRCReconfiguration may need to be identified. In addition, an id for a migration operation itself may be included. That is, an id of an integer distinguishable based on a migrating IAB node may be included. Based on the information, although RRCReconfiguration is to be used by the corresponding DU for the same target descendant node, the RRCReconfiguration may be distinguished based on which IAB node is to perform migration among ancestor nodes. Regarding the same, a migration id related to the migrating IAB node may be included in the RRCReconfiguration message. That is, for configuration information of descendant nodes in association with migration of a predetermined migrating IAB node, the donor CU may include a migrating IAB node-related id of the corresponding migrating IAB node in RRCReconfiguration and may also include the corresponding migrating IAB node-related id in an F1AP message that includes and transfer the RRCReconfiguration message. Hereinafter, the information may be used as one of the conditions for transferring an RRCReconfiguration message in a wireless manner.

In order to store multi-delayed RRCReconfiguration, the DU may store a delayed RRCReconfiguration in a separate variable for each MCG/SCG. In addition, it may be associated with a migrating IAB node-related id and may be stored in each variable.

Conditions for transfer of the RRCReconfiguration message by the DU to a target descendant node in a wireless manner may be as follows.
An IAB node MT co-located with the DU has successfully applied the its RRCReconfiguration received from parent node via which transferred delayed RRCreconfiguration; or
In case that an IAB node MT that is co-located with the DU successfully applies received RRCReconfiguration and the id of a migrating IAB node is included in the RRCReconfiguration message, and an RRCReconfiguration message that is stored by being associated with the id of the corresponding migrating IAB node is present in the DU, the DU may transfer the corresponding RRCReconfiguration to a target descendant node,
In case that an IAB node co-located with the DU successfully applies a received RRC Reconfiguration message,
In case that a co-located IAB node MT receives a HO command and successfully completes the same,
Co-located IAB node MT has successfully completed the random access procedure on the migration; or
Co-located IAB node MT has successfully transmitted RRCReconfigurationComplete msg to its target cell; or
Co-located IAB node MT has successfully completed the migration to the target cell

A target descendent TAB node that receives the message may perform configuration included in the corresponding RRCReconfiguration. In case that a migrating IAB node-related id of the delayed RRCReconfiguration is present in the RRCReconfiguration, whether a delayed RRCReconfiguration message associated with the corresponding id is stored in a corresponding DU is identified. In case that the received RRCReconfiguration is successfully applied, the corresponding stored RRCReconfiguration message may be transferred to an MT of the target IAB node again in a wireless manner.

In case that the DU receives the delayed RRCReconfiguration message, if another RRCReconfiguration message or another RRC message to be transmitted to the same target descendant node is received from the donor CU before the DU transfers the delayed RRCReconfiguration message to the mentioned target descendant node in a wireless manner, the DU may replace the existing delayed RRCReconfiguration message that has been stored with a newly received message (in case that another RRCReconfiguration message is received) or the DU may discard the delayed RRCReconfiguration message (in case that another RRC message is received). Subsequently, the DU may directly transfer the received RRCReconfiguration message or RRC message to the target descendant node in a wireless manner.

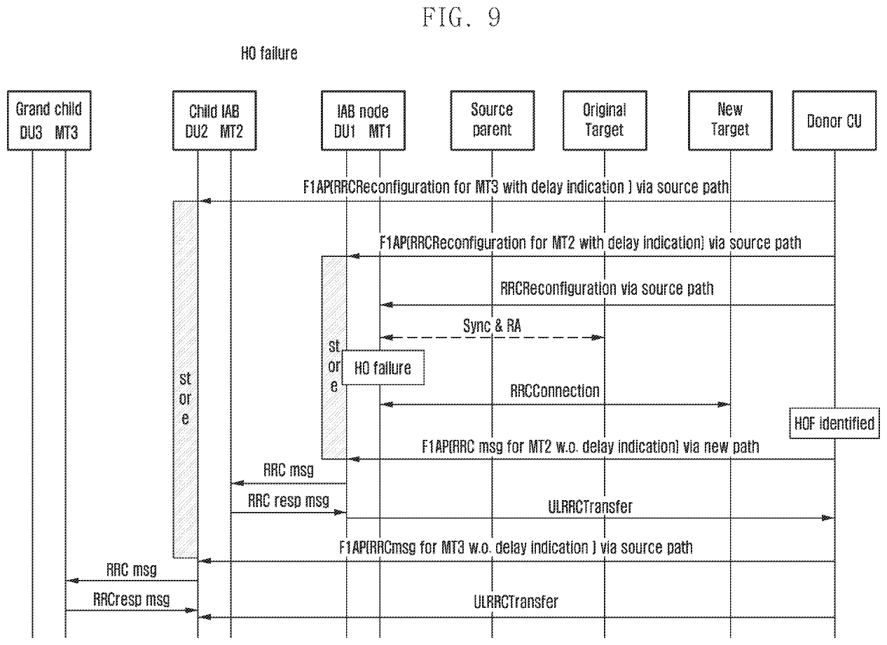

FIG. 9 is a diagram illustrating operation performed in the case of failure of migration of a migrating node when a scheme in which a DU stores configuration information is applied, according to an embodiment of the disclosure.

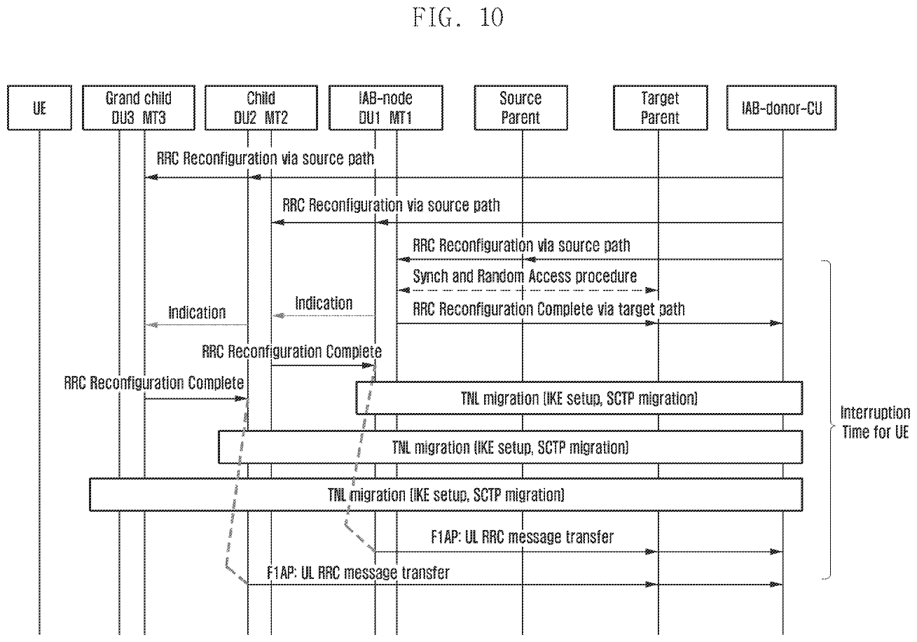

Referring to FIG. 9, a migrating IAB node is IAB node 1. Delayed RRCReconfiguration information for IAB node 3 and IAB node 2, which are descendant nodes of IAB node 1 and are considered as target descendant nodes, has been received by a DU (i.e., DU2) of TAB node 2 and a DU of IAB node 1. In this state, in case that the migrating TAB node receives a migration command from a donor CU via reception of RRCReconfiguration, if handover failure occurs during a process in which TAB node 1 performs migration, an MT (MT1) of the IAB node 1 may select a new target cell via an RRCReestablishment process or a separate process so as to perform RRC connection establishment. After the RRC establishment, the donor CU recognizes the existence of descendant nodes of the corresponding established IAB node 1, and transfers an RRCReconfiguration message to be transmitted to each descendant node, that is, IAB node 3 and IAB node 2, to a parent node of each descendant node via an F1AP for reattempting RRC connection establishment of the corresponding descendant nodes. In the state in which the DU of each parent node receives and stores delayed RRCReconfiguration in advance but does not transfer yet, and receives another RRCReconfiguration, the DU of each parent node replaces the existing delayed RRCReconfiguration message with a new RRCReconfiguration message, and may immediately transfer the same to the target descendant node in a wireless manner. The target descendant nodes that receives the RRCReconfiguration may apply the corresponding configuration, and may transfer a complete message to the donor CU via a parent node thereof. FIG. 10 is a diagram illustrating an embodiment of the case in which an MT withholds and applies the configuration information at a predetermined case according to an embodiment of the disclosure.

Referring to FIG. 10, in case that a donor CU transfers an RRCReconfiguration message storing RRC configuration information to a DU and a child node, a target child node directly applies the corresponding RRCReconfiguration message, which has been withheld, at a predetermined point in time.

The donor CU takes into consideration the topology of a migrating node and identifies whether the corresponding node has a child node. In case that a child node is present, the donor CU transfers configuration information that takes into consideration a target path of the migrating node to each child node before transferring a handover command to the migrating IAB node. In case that the DU is connected to a new target donor or a new donor DU, new transport network layer (TNL) address information to be used, IP addresses to be allocated to the DU, and pieces of other configuration information of the DU may be transferred as the information. The information may be as follows.

BAP mapping configuration: routing mapping information used in the BAP of a corresponding IAB node, which may add or remove the following information.

>>BAP Routing ID
>>Next-Hop BAP Address

gNB-DU Resource Configuration: scheduling configuration information of a cell operated by a DU and scheduling configuration information of a cell operated by a child node, which may add/mod/release the following information.

```
Activated Cells to Be Updated List
  >Activated Cells To Be Updated List Item
    >> NR CGI
    >>CHOICE IAB-DU Cell Resource Configuration-Mode-Info
      >>>TDD
        >>>>TDD Info
          >>>>>gNB-DU Cell Resource Configuration-TDD
      >>>FDD
        >>>>FDD Info
          >>>>>gNB-DU Cell Resource Configuration-FDD-UL
          >>>>>gNB-DU Cell Resource Configuration-FDD-DL
Child-Nodes List
  >Child-Nodes List Item
    >>gNB-CU UE F1AP ID
    >>gNB-DU UE F1AP ID
    >>Child-Node Cells List
      >>>Child-Node Cells List Item
        >>>>NR CGI
        >>>>CHOICE IAB-DU Cell Resource Configuration-Mode-Info
          >>>>>TDD
            >>>>>>TDD Info
              >>>>>>>gNB-DU Cell Resource Configuration-TDD
          >>>>>FDD
            >>>>>>FDD Info
              >>>>>>>gNB-DU Cell Resource Configuration-FDD-UL
              >>>>>>> gNB-DU Cell Resource
              Configuration-FDD-DL
        >>>>IAB STC Info
        >>>>RACH Config Common
        >>>>RACH Config Common IAB
        >>>>CSI-RS Configuration
        >>>>SR Configuration
        >>>>PDCCH Configuration SIB1
        >>>>SCS Common
        >>>>Multiplexing Info
```

IAB TNL Address Allocation: TNL address information that a CU request a DU to allocate, and transfers an IP address and a prefix. The information may add/mod/release the following information.

```
IAB IPv4 Addresses Requested
CHOICE IAB IPv6 Request Type
  >IPv6 Address
    >>IAB IPv6 Addresses Requested
  >IPv6 Prefix
    >>IAB IPv6 Address Prefixes Requested
IAB TNL Addresses To Remove List
  >IAB TNL Addresses To Remove Item
    >>IAB TNL Address
```

Although the pieces of information have been transmitted via an F1-AP message, the information may be included in an RRCReconfiguration message and may be transmitted. According to an embodiment, the F1-AP message may be added to the RRCReconfiguration message and may be transmitted.

The donor CU may determine migration of the migrating IAB node, and may transfer, to descendant nodes (i.e., a child, a child of the child, or the like) of the migrating node, the RRCReconfiguration message including (the above-mentioned) information to be newly configured in association with the donor DU in a corresponding target path. In this instance, the RRCReconfiguration message is transmitted before migration by considering a migrating operation as a start point, and thus the RRCReconfiguration message may be transferred using a source path.

In case that the donor CU transfers the RRCReconfiguration message to a descendant TAB node which is a target, the donor CU may include the RRCReconfiguration message in the F1AP message and may transfer the same to a DU part of a parent IAB node of the target descendant node. In this instance, in the F1AP message, the target descendant node is indicated as a destination.

In the case in which the DU of the parent IAB node transfers the message, the DU of the parent node may transmit the message to the target descendant node immediately after reception of the message according to scheduling. The target descendant node may receive the corresponding message and may store the message in an MT first, as opposed to immediately applying the message, and may apply the stored RRCReconfiguration message when a predetermined event occurs.

The RRCReconfiguration message may include an indicator. The indicator may indicate that the received RRCReconfiguration message needs to be stored or buffered in the MT in advance, and needs to be applied when a predetermined event occurs.

In addition, the RRCReconfiguration message may include a unique id that identifies the message in association with a migrating TAB node. The id may bean RRC transaction id used for the corresponding RRCReconfiguration message, or an integer value that the donor CU arbitrarily defines may be an id. In case that the MT stores a plurality of delayed RRCReconfiguration messages, each RRCReconfiguration needs to be distinguished by an id. In addition, an id for a migration operation itself may be included. That is, an id of an integer distinguishable based on a migrating IAB node may be included. Based on the information, although a delayed RRCReconfiguration is to be applied by the MT that stores the corresponding message, the delayed RRCReconfiguration may be distinguished based on which IAB node is to perform migration among ancestor nodes.

In order to store multi-delayed RRCReconfiguration, the MT may store a delayed RRCReconfiguration in a separate variable for each MCG/SCG. In addition, the delayed RRCReconfiguration may be associated with a migrating IAB node-related id and may be stored in each variable.

A condition for applying the RRC reconfiguration message by the MT may be as follows.
In case that the MT receives, from a parent node that transfers the delayed RRCreconfiguration message, a message or signal indicating application of the stored message. In this instance, the predetermined message or signal may be a BAP control PDU or a MAC CE or a physical layer signal (PDCCH DCI). In the message/signal, an id indicating a delayed RRCReconfiguration to be performed may be included. The id may be a migrating IAB node-related id included in each delayed RRCReconfiguration. Alternatively, an id may be a transaction id of RRCReconfiguration to be performed.

Accordingly, a condition for transmitting a message/signal indicating application of RRCReconfiguration from a DU of the parent node that transfers delayed RRCReconfiguration to the MT of the target descendant node, or from the parent node to the MT of the target descendant node may be as follows.
The DU of the parent node transmits a delayed RRCReconfiguration message in advance, and a message/signal indicating application of the corresponding delayed RRCReconfiguration is not transmitted, and
A colocated MT of the DU successfully applies its (delayed) RRCReconfiguration message; or
In case that a message/signal indicating application of delayed RRCReconfiguration is received from a parent IAB node DU
In all the cases, the same migrating IAB node-related id needs to be included in a (delayed) RRCReconfiguration message and an application message/signal.

As described above, the DU of the parent node needs to be aware that the DU has been transmitted a delayed RRCReconfiguration message to a predetermined child TAB node, and thus an F1AP message including the delayed RRCReconfiguration message and transmitted from the donor CU needs to include an indication indicating that the embedded RRC message is delayed RRCReconfiguration. In addition, together with the indicator, the corresponding migrating IAB node-related id may also be included.

Describing with reference to the case of FIG. 10, the donor CU transfers a delayed RRCReconfiguration message to a target descendant node (e.g., MT3 and MT2). In this instance, the donor CU may include the delayed RRCReconfiguration message in an F1AP message and may add a migrating IAB node (IAB node 1)-related id and/or an indicator indicating that an RRC message included in the F1AP message is the delayed RRCReconfiguration, and may transfer the same to the DU of the parent node of the target descendant node. The DU of each parent node may transfer the delayed RRCReconfiguration message included in the corresponding F1AP to the corresponding target descendant node in a wireless manner according to its scheduling. The MT of the corresponding descendance nodes identifies an indicator indicating delayed RRCReconfiguration from a message of the received RRCReconfiguration, and may store the corresponding message, separately. In this instance, the MT of a descendant node may associate a migrating IAB node-related id with the received RRCReconfiguration message, and may store the corresponding message.

Subsequently, in case that the migrating IAB node receives a HO command and successfully applies RRCReconfiguration, the DU of the migrating IAB node may transfer an RRCReconfig application message to child node 2 to which delayed RRCReconfiguration has been transferred since the migrating IAB node is aware that its DU has transmitted the delayed RRCReconfiguration to child node 2 and the received RRCReconfiguration is successfully applied. The message may include a migrating IAB node-related id.

The MT of child node 2 that receives the message may identify the migrating IAB node id included in the message, and may apply the corresponding delayed RRCReconfiguration. Alternatively, in case that an id is not included, the MT of child node 2 may apply delayed RRCReconfiguration that the MT has been possessing. In case that the application is successfully performed, child node 2 may also transmit a RRCReconfig application message to child node 3 to which delayed RRCReconfiguration has been transferred. With reference to a migrating IAB node-related id included in the message, MT3 of child node 3 that receives the same may apply a delayed RRCReconfiguration message including the corresponding id, which is currently stored in the MT3.

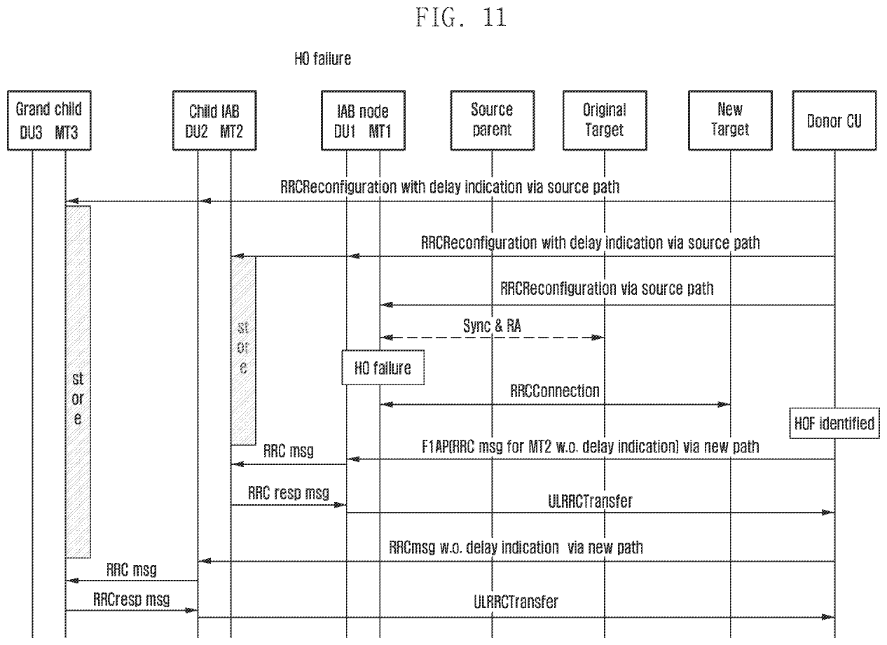

FIG. 11 is a diagram illustrating an embodiment of failure of handover in the case in which an MT withholds and applies configuration information at a predetermined case according to an embodiment of the disclosure.

Referring to FIG. 11, in case that an MT receives a delayed RRCReconfiguration message and another RRC message is given, the MT may overwrite the delayed RRCReconfiguration that has been stored with a newly received RRC message, and may immediately apply the same. According to another embodiment, in case that the newly received RRC message is another delayed RRCReconfiguration message, the MT may replace the previous delayed RRCReconfiguration with a new delayed RRCReconfiguration, but does not immediately apply the same, and apply the same when an application event occurs in the same manner as the existing delayed RRCReconfiguration.

In FIG. 11, in the state in which a donor CU provides delayed RRCReconfiguration in advance to node 2 and node 3 based on a migrating node, in case that a donor CU transfers a HO command to the migrating node, the migrating node performs handover. In case that handover fails in the processor, an MT of the migrating IAB node may discover a new target cell and may newly set up an RRC connection. Subsequently, the donor CU recognizes that the corresponding migrating IAB node has a descendant node, and may transfer an RRCReconfiguration message or a required RRC message to each descendant node. Each descendant node that receives the RRC message may apply the newly received RRC message by replacing an existing message although the corresponding descendant node currently stores delayed RRCReconfiguration.

According to various embodiments of the disclosure, in case that a backhaul and access hole combined node needs to connect to another parent node depending on mobility or a channel condition in a wireless communication system, a mobile termination (MT) part may establish a connection via a legacy handover operation but a distributed unit (DU) included in the same IAB node may need to receive a new configuration via a new parent node. In this instance, until the new configuration is applied, the DU is incapable of performing operation, and a child IAB node connected to the corresponding IAB node or UEs accessing the IAB node may not receive a service from a network.

According to various embodiments of the disclosure, in the case of handover of a migrating IAB node, the migrating IAB node may receive information for configuring a DU together when receiving configuration information via RRC before handover is performed, or may receive the information before handover. Through the above, the configuration information of the DU transferred in advance may be applied when the MT part performs handover.

According to various embodiments of the disclosure, by receiving DU configuration information before handover or reception of conditional handover configuration information in a wireless communication system, and applying the DU configuration information when conditional handover is performed, a data service delay time that used to be incurred due to reception and application of a DU configuration after RRC connection may be reduced.

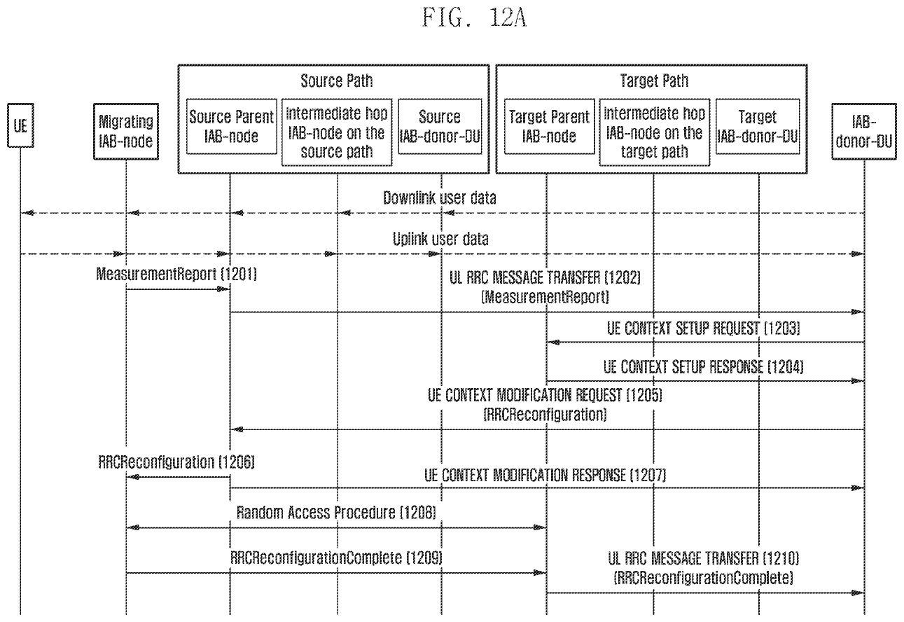

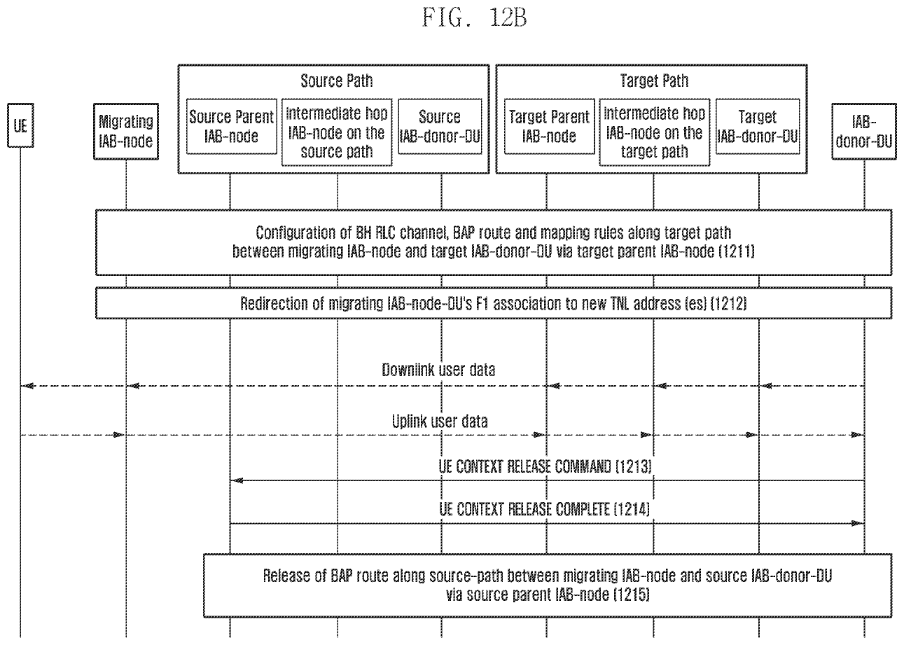

FIG. 12A and FIG. 12B are diagrams illustrating a process of migration of an IAB node in a wireless communication system according to an embodiment of the disclosure.

Embodiments of FIG. 12A and FIG. 12B illustrate legacy IAB node migration. Embodiments of FIG. 12 illustrate an IAB topology adaptation call flow of 3GPP TS 38.401.

The embodiments of FIG. 12A and FIG. 12B illustrate migration of an intra donor. The following items illustrate operation in each step.

In operation 1201, an TAB-MT that performs migration transmits a MeasurementReport message to a source parent node IAB-DU. The measurement report is based on a measurement configuration that the IAB-MT receives in advance from an IAB-donor-CU. (Migrating IAB-MT sends a MeasurementReport message to the source parent node IAB-DU. This report is based on a Measurement Configuration the migrating IAB-MT received from the IAB-donor-CU before.)

In operation 1202, the source parent node IAB-DU transmits a UL RRC MESSAGE TRANSFER message to the IAB-donor-CU in order to transfer the received MeasurementReport. (The source parent node IAB-DU sends an UL RRC MESSAGE TRANSFER message to the IAB-donor-CU to convey the received MeasurementReport.)

In operation 1203, the IAB-donor-CU transmits a UE CONTEXT SETUP REQUEST message to a target parent node IAB-DU in order to produce UE context for migration of the IAB-MT, and to configure one or more bearers. (The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.) In operation 1204, the target parent node IAB-DU responds to the IAB-donor-CU via a UE CONTEXT SETUP RESPONSE message. (The target parent node IAB-DU responds to the IAB-donor-CU with a UE CONTEXT SETUP RESPONSE message.)

In operation 1205, the IAB-donor-CU transmits a UE CONTEXT MODIFICATION REQUEST message to the source parent node IAB-DU. The UE CONTEXT MODIFICATION REQUEST message includes a produced RRCReconfiguration message. The RRCReconfiguration message includes a default BH RLC channel and a default BAP routing ID configuration for UL F1-C/non-F1 traffic mapping of the target path. The RRCReconfiguration message may include an additional BH RLC channel. This operation may also include allocation of a TNL address(es) routable via a target IAB-donor-DU. The new TNL address(es) may be included in the RRCReconfiguration message as a replacement for the RNL address(es) routable via a source IAB-donor-DU. In case that an IPsec tunnel mode is used to protect the F1 and non-F1 traffic, the allocated TNL address is an external IP address. In case that a source path and a target path use the same IAB-donor-DU, the TNL address may not need to be changed. A transmission action indicator of the UE CONTEXT MODIFICATION REQUEST message indicates stop of data transmission to the migrating IAB-node. (The IAB-donor-CU sends a UE CONTEXT MODIFICATION REQUEST message to the source parent node IAB-DU, which includes a generated RRCReconfiguration message. The RRCReconfiguration message includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.)

In operation 1206, the source parent node IAB-DU transfers the received RRCReconfiguration message to the migrating IAB-MT. (The source parent node IAB-DU forwards the received RRCReconfiguration message to the migrating IAB-MT.)

In operation 1207, the source parent node IAB-DU responds to the IAB-donor-CU via a UE CONTEXT MODIFICATION RESPONSE message. (The source parent node IAB-DU responds to the IAB-donor-CU with the UE CONTEXT MODIFICATION RESPONSE message.)

In operation 1208, a random access procedure is performed in the target parent node IAB-DU. (A Random Access procedure is performed at the target parent node IAB-DU.)

In operation 1209, the migrating IAB-MT responds to the target parent node IAB-DU via an RRCReconfigurationComplete message. (The migrating IAB-MT responds to the target parent node IAB-DU with an RRCReconfigurationComplete message.)

In operation 1210, the target parent node IAB-DU transmits a UL RRC MESSAGE TRANSFER message to the IAB-donor-CU in order to transfer the received RRCReconfigurationComplete message. In addition, an uplink packet may be transferred to the migrating IAB-MT, and may be transferred to the IAB-donor-CU via the target parent node IAB-DU. The UL packet belongs to an IAB-MT's own signal and, optionally, data traffic. (The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MTs own signalling and, optionally, data traffic.)

In operation 1211, the IAB-donor-CU configures BH RLC channels and BAP-sublayer routing entries in the target path between the target parent IAB-node and the target IAB-donor-DU as well as DL mapping of the target IAB-donor-DU for a target path for migration of the IAB-node. The configuration may be performed at the early stage, for example, immediately after operation 1203. The IAB-donor-CU may configure an additional BH RLC channel for the migrating IAB-MT via an RRC message. (The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.)

In operation 1212, the F1-C connection is switched to use the new TNL address of the migrating IAB-node, and the IAB-donor-CU updates the migrating IAB-node on the UL BH information associated with each GTP-tunnel. In this operation, UL FTEID and DL FTEID associated with each GTP-tunnel may also be updated. All F1-U tunnels are switched to use the new TNL address of the migrating IAB-node. This operation may use non-UE related signaling in an E1 and/or F1 interface and may provide updated UP configurations for the F1-U tunnels of multiple connected UEs or child IAB-MTs. The IAB-donor-CU may also update the UL BH information related to non-UP traffic. Implementation needs to avoid a potential competitive condition. That is, configurations that conflict are implemented not to be concurrently performed using a UE-related procedure and a non-UE-related procedure. (12.

The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.)

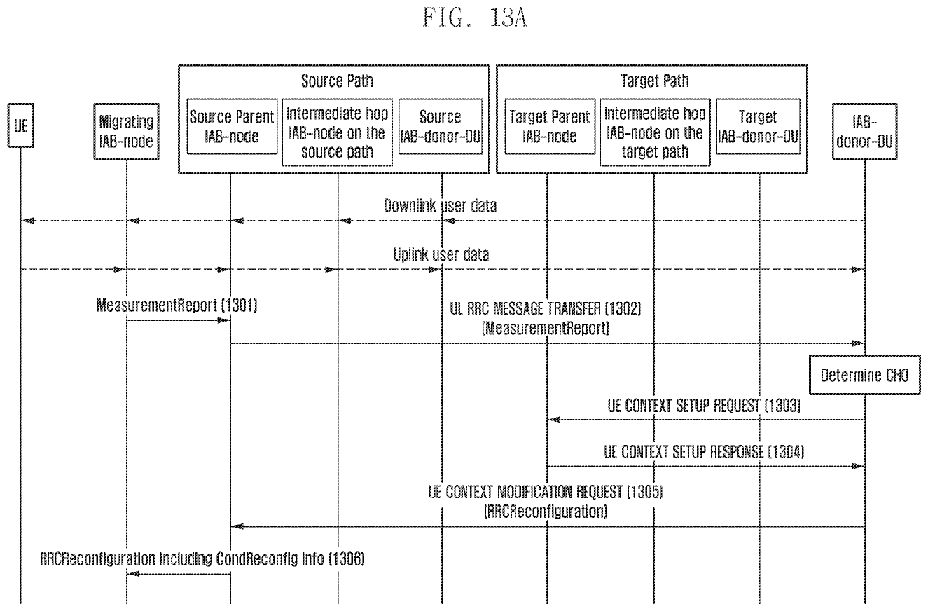

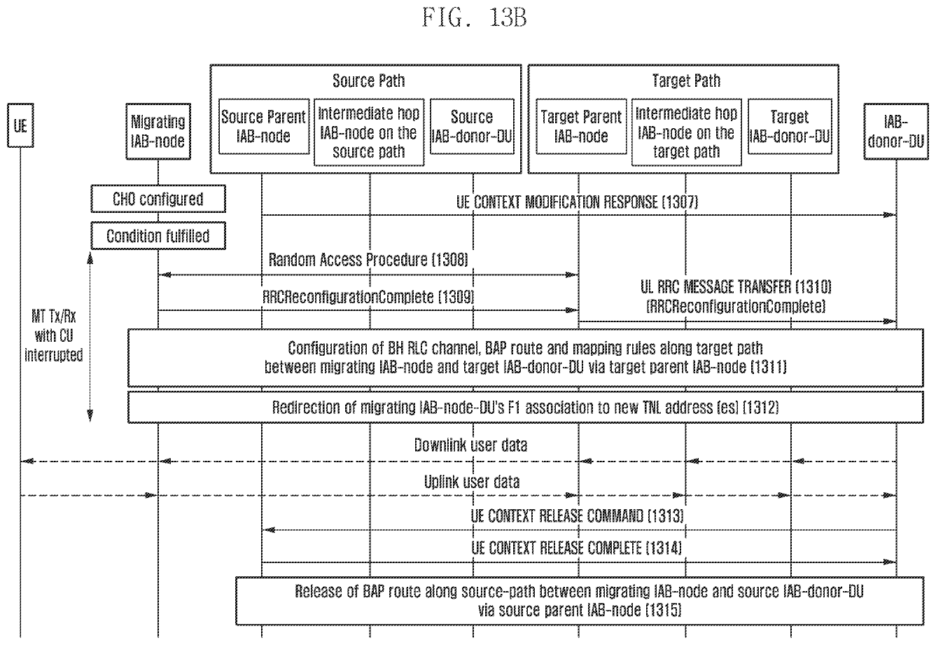

In operation 1213, the IAB-donor-CU transmits a UE CONTEXT RELEASE COMMAND message to the source parent node IAB-DU. (13. The IAB-donor-CU sends a UE CONTEXT RELEASE COMMAND message to the source parent node IAB-DU.) In operation 1214, the source parent node IAB-DU releases the context of the migrating IAB-MT and responds to the IAB-donor-CU via a UE CONTEXT RELEASE COMPLETE message. (14. The source parent node IAB-DU releases the migrating IAB-MTs context and responds to the IAB-donor-CU with a UE CONTEXT RELEASE COMPLETE message.) In operation 1215, the IAB-donor-CU releases BH RLC channels and BAP-sublayer routing entries in the source path between the source parent IAB-node and the source IAB-donor-DU. (15. The IAB-donor-CU releases BH RLC channels and BAP-sublayer routing entries on the source path between source parent IAB-node and source IAB-donor-DU.) FIGS. 13A and 13B are diagrams illustrating a process of receiving and applying DU and BAP configuration information after accessing a target parent node in the case in which conditional handover (CHO) is applied to IAB migration in a wireless communication system according to an embodiment of the disclosure.

In the embodiments of FIG. 13A and FIG. 13B, RRC CHO is applied. IAB-related information is not prefetched. That is, only a genuine CHO procedure is applied.

In operation 1301, a migrating IAB-MT transmits a MeasurementReport message to a source parent node IAB-DU. The MeasurementReport message is based on a measurement configuration that the migrating IAB-MT receives in advance from an IAB-donor-CU. (1. migrating IAB-MT sends a MeasurementReport message to the source parent node IAB-DU. This report is based on a Measurement Configuration the migrating IAB-MT received from the IAB-donor-CU before.)

In operation 1302, the source parent node IAB-DU transmits an UL RRC MESSAGE TRANSFER message to the IAB-donor-CU, so as to transfer the received MeasurementReport. (2. The source parent node IAB-DU sends an UL RRC MESSAGE TRANSFER message to the IAB-donor-CU to convey the received MeasurementReport.)

In operation 1302-1, the IAB donor CU may determine conditional handover based on the given measurementReport. In this process, a target parent IAB node that operates a target cell may be determined.

In operation 1303, the IAB-donor-CU transmits a UE CONTEXT SETUP REQUEST message to a target parent node IAB-DU in order to produce UE context for the migration TAB-MT, and to configure one or more bearers. The bearers may be used by the migrating IAB-MT for its own signal, and, optionally, data traffic. (3. The TAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.)

In operation 1303-1, the UE CONTEXT SETUP REQUEST message may include a conditional handover indicator.

In operation 1304, the target parent node IAB-DU responds to the TAB-donor-CU via a UE CONTEXT SETUP RESPONSE message. (4. The target parent node IAB-DU responds to the IAB-donor-CU with a UE CONTEXT SETUP RESPONSE message.)

In operation 1305, the IAB-donor-CU transmits a UE CONTEXT MODIFICATION REQUEST message including a produced RRCReconfiguration message to the source parent node IAB-DU. In case that an IPsec tunnel mode is used to protect the F1 and non-F1 traffic, an allocated TNL address is an external IP address. In case that a source path and a target path use the same IAB-donor-DU, the TNL address may not need to be changed. A transmission action indicator of the UE CONTEXT MODIFICATION REQUEST message indicates stop of data transmission to the migrating IAB-node. (5. The IAB-donor-CU sends a UE CONTEXT MODIFICATION REQUEST message to the source parent node IAB-DU, which includes a generated RRCReconfiguration message. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.)

In operation 1305-1, information associated with a condition for performing conditional handover to the target cell in the target parent IAB node may be additionally included in the RRCReconfiguration message, and configuration information to be applied in the corresponding target cell may be included. As the configuration information, the RRCReconfiguration message provided in an octet string may include a default BH RLC channel and a default BAP routing ID configuration for UL F1-C/non-F1 traffic mapping in the target path. An additional BH RLC channel may be included. This operation may also include allocation of TNL address(es) routable via a target IAB-donor-DU. The new TNL address(es) may be included in the RRCReconfiguration message as a replacement for the TNL address(es) routable via a source IAB-donor-DU. (RRCReconfiguration message as an octet string includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU.)

In operation 1306, the source parent node IAB-DU transfers the received RRCReconfiguration message to the migrating IAB-MT. (6. The source parent node IAB-DU forwards the received RRCReconfiguration message to the migrating IAB-MT.) RRCReconfiguration includes CondReconfig information. A default BH RLC channel and a default BAP routing ID configuration (which may be an additional BH RLC channel) for UL F1-C/non-F1 traffic mapping in the target path, and the TNL address(es) routable via the target IAB-donor-DU may be included in the RRCReconfiguration message. The new TNL address, instead of the TNL address, may be included in the RRCReconfiguration message. Routing may be performed via the source IAB-donor-DU.

In operation 1306-1, the RRCReconfiguration message may include a condition for conditional handover and configuration information, and the configuration information may be an RRCReconfiguration message in the form of an octet string that has been described in operation 1305-1. The migrating IAB node that receives the information may store the conditional handover condition and configuration information, and may start evaluating a condition.

In operation 1307, the source parent node IAB-DU responds to the IAB-donor-CU via a UE CONTEXT MODIFICATION RESPONSE message. (7. The source parent node IAB-DU responds to the IAB-donor-CU with the UE CONTEXT MODIFICATION RESPONSE message.)

In operation 1307-1, in case that a given condition is satisfied at any time, the migrating IAB node may apply the configuration and may perform handover to the target parent TAB node corresponding to the condition.

In operation 1308, a random access procedure is performed in the target parent node IAB-DU. (8. A Random Access procedure is performed at the target parent node IAB-DU.)

In operation 1309, the migrating IAB-MT responds to the target parent node IAB-DU via an RRCReconfigurationComplete message. (9. The migrating IAB-MT responds to the target parent node IAB-DU with an RRCReconfigurationComplete message.)

In operation 1310, the target parent node IAB-DU transmits a UL RRC MESSAGE TRANSFER message to the IAB-donor-CU in order to transfer the received RRCReconfigurationComplete message. In addition, an uplink packet may be transmitted from the migrating IAB-MT, and may be transferred to the IAB-donor-CU via the target parent node IAB-DU. The UL packet belongs to an IAB-MTs own signal and, optionally, data traffic. (10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MTs own signalling and, optionally, data traffic.)

In operation 1311, the IAB-donor-CU configures BH RLC channels and BAP-sublayer routing entries in the target path between the target parent IAB-node and target IAB-donor-DU as well as DL mapping of the target IAB-donor-DU for a target path of the migrating IAB-node. The configuration may be performed at the early stage, for example, immediately after operation 1303. The IAB-donor-CU may configure an additional BH RLC channel for the migrating IAB-MT via an RRC message. (11. The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.)

According to an embodiment, in operation 1311, update along the target path may be performed immediately after operation 1303. In case that the MT finally accesses the target cell, the configuration may be transmitted to the migrating node via a UE context mode.

In operation 1312, the F1-C connection is switched to use the new TNL address of the migrating IAB-node, and the IAB-donor-CU updates the migrating IAB-node on the UL BH information associated with each GTP-tunnel. This operation may also update UL FTEID and DL FTEID associated with each GTP-tunnel. All F1-U tunnels are switched to use the new TNL address(es) of the migrating IAB node. This operation may use non-UE related signaling in an E1 and/or F1 interface and may provide updated UP configurations for the F1-U tunnels of multiple connected UEs or child IAB-MTs. The TAB-donor-CU may also update the UL BH information related to non-UP traffic. Implementation needs to avoid a potential competitive condition. That is, configurations that conflict are implemented not to be concurrently performed using a UE-related procedure and a non-UE-related procedure. (12.

The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.)

In operation 1313, the IAB-donor-CU transmits a UE CONTEXT RELEASE COMMAND message to the source parent node IAB-DU. (13. The IAB-donor-C U sends a UE CONTEXT RELEASE COMMAND message to the source parent node IAB-DU.)

In operation 1314, the source parent node IAB-DU releases the context of the migrating IAB-MT and responds to the IAB-donor-CU via a UE CONTEXT RELEASE COMPLETE message. (14. The source parent node IAB-DU releases the migrating IAB-MT's context and responds to the IAB-donor-CU with a UE CONTEXT RELEASE COMPLETE message.)

In operation 1315, the IAB-donor-CU releases BH RLC channels and BAP-sublayer routing entries in the source path between a source parent IAB-node and a source IAB-donor-DU. (15. The IAB-donor-CU releases BH RLC channels and BAP-sublayer routing entries on the source path between source parent IAB-node and source IAB-donor-DU.)

The embodiment illustrates the case of intra donor migration. In case that inter donor migration is taken into consideration, operation 1303 and operation 1304 may be performed between the target parent IAB node in the target donor CU and the target donor CU. In operation 1309, transmission is performed from the migrating IAB node to the target parent IAB node in the target donor CU. In operation 1310, transferring is performed from the target parent IAB node in the target donor CU to the target donor CU. Operations 1311 and 1312 may be application of configuration of the target parent IAB node in the target donor CU and the path, and DU's F1 association.

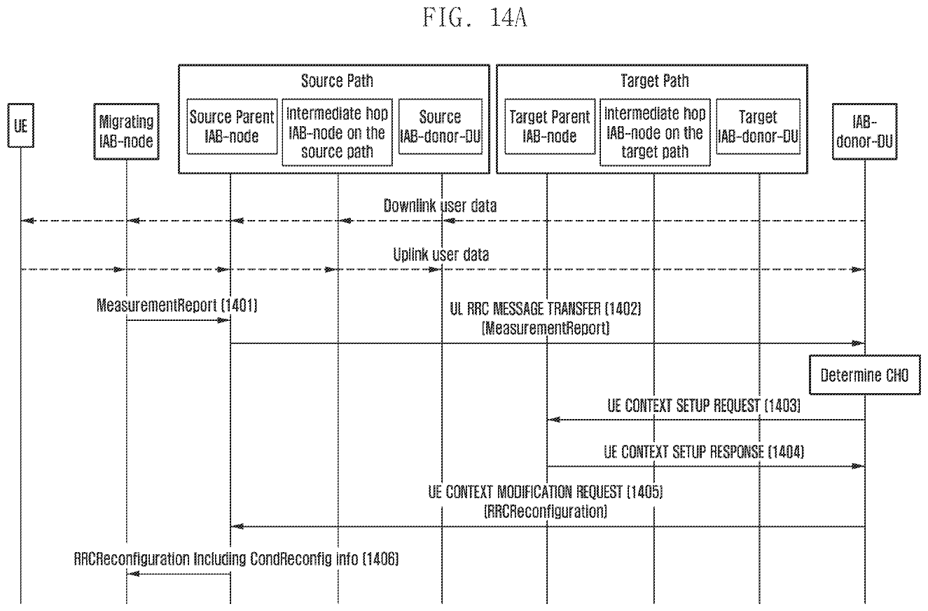

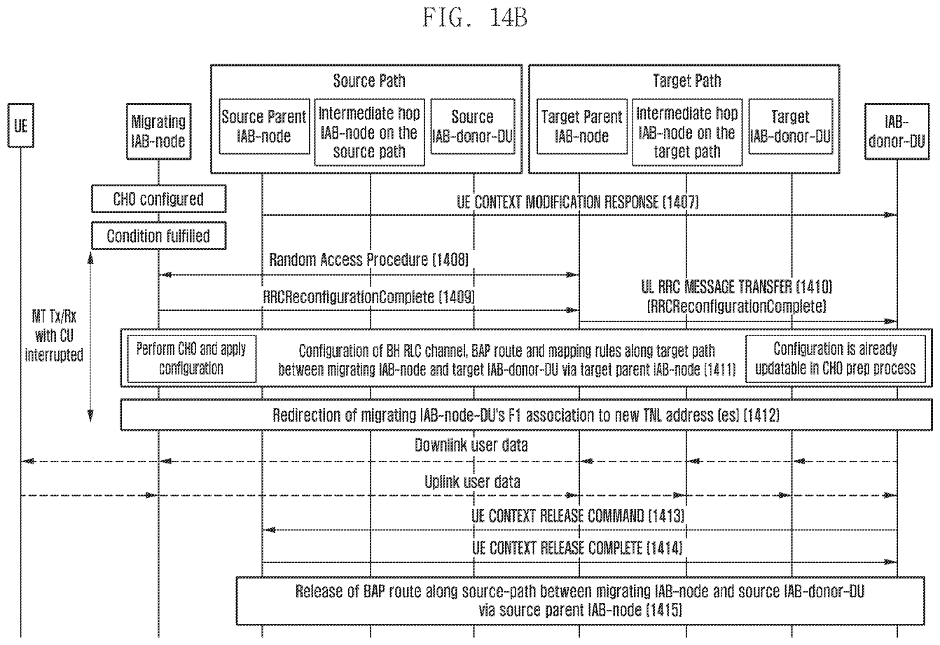

FIGS. 14A and 14B are diagrams illustrating a process of transferring DU and BAP configuration information via an RRC signal in the case in which conditional handover is applied to IAB migration in a wireless communication system according to an embodiment of the disclosure.

The embodiments of FIG. 14A and FIG. 14B illustrate a process in which DU/BAP configuration is performed via RRC signaling.

In operation 1401, a migrating IAB-MT transmits a MeasurementReport message to a source parent node IAB-DU. The MeasurementReport is based on a measurement configuration that the migrating IAB-MT receives in advance from an IAB-donor-CU. (1. migrating IAB-MT sends a MeasurementReport message to the source parent node IAB-DU. This report is based on a Measurement Configuration the migrating IAB-MT received from the IAB-donor-CU before.)

In operation 1402, the source parent node IAB-DU transmits an UL RRC MESSAGE TRANSFER message to the IAB-donor-C U, so as to transfer the received MeasurementReport. (2. The source parent node IAB-DU sends an UL RRC MESSAGE TRANSFER message to the IAB-donor-CU to convey the received MeasurementReport.)

In operation 1402-1, the IAB donor CU may determine conditional handover based on the given measurementReport. In this process, a target parent IAB node that operates a target cell may be determined.

In operation 1403, the IAB-donor-CU transmits a UE CONTEXT SETUP REQUEST message to a target parent node IAB-DU in order to produce UE context for the migration IAB-MT, and to configure one or more bearers. The bearers may be used by the migrating IAB-MT for its own signal, and, optionally, data traffic. (3. The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.)

In operation 1403-1, the UE CONTEXT SETUP REQUEST message may include a conditional handover indicator.

In operation 1404, the target parent node IAB-DU responds to the IAB-donor-CU via a UE CONTEXT SETUP RESPONSE message. (4. The target parent node IAB-DU responds to the IAB-donor-CU with a UE CONTEXT SETUP RESPONSE message.)

In operation 1405, the IAB-donor-CU transmits a UE CONTEXT MODIFICATION REQUEST message including a produced RRCReconfiguration message to the source parent node IAB-DU. In case that an IPsec tunnel mode is used to protect the F1 and non-F1 traffic, an allocated TNL address is an external IP address. In case that a source path and a target path use the same IAB-donor-DU, the TNL address may not need to be changed. A transmission action indicator of the UE CONTEXT MODIFICATION REQUEST message indicates stop of data transmission to the migrating IAB-node. (5. The IAB-donor-CU sends a UE CONTEXT MODIFICATION REQUEST message to the source parent node IAB-DU, which includes a generated RRCReconfiguration message. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.)

In operation 1405-1, information associated with a condition for performing conditional handover to the target cell in the target parent IAB node may be additionally included in the RRCReconfiguration message, and configuration information to be applied in the corresponding target cell may be included. As the configuration information, the RRCReconfiguration message provided in an octet string may include a default BH RLC channel and a default BAP routing ID configuration for UL F1-C/non-F1 traffic mapping in the target path. An additional BH RLC channel may be included. This operation may also include allocation of a TNL address(es) routable via a target IAB-donor-DU. The new TNL address(es) may be included in the RRCReconfiguration message as a replacement for the TNL address(es) routable via a source IAB-donor-DU. (RRCReconfiguration message as an octet string includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU.)

In operation 1405-2, the RRCReconfiguration message mentioned in operation 1405-1 may include pieces of information needed for DU and BAP configuration after accessing an associated corresponding target cell, in addition to the condition information and configuration information. The information may be information made by the IAB donor CU (in the case of intra donor CU migration) or target IAB donor CU (in the case of inter donor CU migration), and may be associated with a conditional configuration id or a target cell id and may be signaled.

For example, it may have the following hierarchy.
RRCReconfiguration
ConditionalReconfiguration IE
condReconfig Id
Condition
RRCReconfig
DU/BAP config (in the form of an F1AP message provided in octet string, associated with condReconfig Id)

That is, the configuration information may be an F1AP message and may be expressed as an octet string, and may be associated with a configuration id of a conditional handover given in RRC or may be associated with a target cell id. The information included in the configuration may include DU configuration and BAP config information, and IAB UP configuration information.

The BAP configuration information may be information associated with BH RLC channels and BAP sublayer routing entities in the target path (BH RLC channels and BAP-sublayer routing entries on the target path), and may be information included in a BAP mapping configuration message in an F1-AP signal.

The IAB UP configuration information may be a parameter including a UL mapping configuration and UL/DL UP TNL information (parameters including UL mapping configuration and the UL/DL UP TNL information), and may be information included in an IAB UP Configuration Update message in an F1-AP signal.

The DU configuration information may be information included in a gNB-DU Resource Configuration message in an F1-AP.

In the case of the pieces of information, the IAB donor CU (in the case of an intra-donor migration) or the target IAB donor CU (in the case of an inter-donor migration) receives a positive response from the corresponding target parent IAB node after step 4, configures a message in the F1-AP by determining the content in the CU-CP (F1-AP) in consideration of topology of anode including a parent node thereof and a resource usage state, and transfers the same to RRC in the CU, the RRC in the CU may include the same in conditional handover-related configuration information in RRCReconfiguration in operation 1405.

In operation 1406, the source parent node IAB-DU transfers the received RRCReconfiguration message to the migrating IAB-MT. (6. The source parent node IAB-DU forwards the received RRCReconfiguration message to the migrating IAB-MT.)

RRCReconfiguration includes CondReconfig information. A default BH RLC channel and a default BAP routing ID configuration (which may be an additional BH RLC channel) for UL F1-C/non-F1 traffic mapping in the target path, and the TNL address(es) routable via the target IAB-donor-DU may be included in the RRCReconfiguration message. The new TNL address, instead of the TNL address, may be included in the RRCReconfiguration message. Routing may be performed via the (es) source IAB-donor-DU. The DU may configure a preconfiguration of RRC information (i.e., genuine CHO) and DU predetermined information (a BH RLC channel, a BAP path, and a mapping rule in migrating IAB node)._{<0)} This is not for updating all configurations along the target path.

RRCReconfiguration includes an F1AP msg field. The migrating IAB node may transfer, to the DU, an F1 AP configuration information message related to the corresponding target cell at the time at which a CHO condition is satisfied or at the time at which handover to the corresponding cell is complete.

In operation 1406-1, the RRCReconfiguration message may include a condition for conditional handover and configuration information. The configuration information may be an RRCReconfiguration message in the form of an octet string which has been mentioned in operation 1405-1. The migrating IAB node that receives the information may store the conditional handover condition and configuration information, and may start evaluating a condition.

In operation 1407, the source parent node IAB-DU responds to the TAB-donor-CU via a UE CONTEXT MODIFICATION RESPONSE message. (7. The source parent node IAB-DU responds to the IAB-donor-CU with the UE CONTEXT MODIFICATION RESPONSE message.)

In operation 1407-1, in case that a given condition is satisfied at any time, the migrating IAB node may apply the configuration and may perform handover to the target parent IAB node corresponding to the condition.

In case that the MT of the migrating IAB node receives the DU/BAP configuration information associated with the target cell to which handover is to be performed, in advance in operation 1407-1, the MT part may transfer the corresponding DU/BAP configuration information to a DU part of the IAB node in operation 1407-2. Specifically, the case in which a condition for a target cell to which handover is to be performed is satisfied, the case in which handover is performed since a condition is satisfied, or the point in time at which RRCReconfigurationComplete is transmitted since handover is performed may be the point in time for transferring.

The DU of the migrating IAB node that receives the information may apply the received configuration information.

In operation 1408, a random access procedure is performed in the target parent node IAB-DU. (8. A Random Access procedure is performed at the target parent node IAB-DU.)

In operation 1409, the migrating IAB-MT responds to the target parent node IAB-DU via the RRCReconfigurationComplete message. (9. The migrating IAB-MT responds to the target parent node IAB-DU with an RRCReconfigurationComplete message.)

In operation 1410, the target parent node IAB-DU transmits a UL RRC MESSAGE TRANSFER message to the IAB-donor-CU in order to transfer the received RRCReconfigurationComplete message. In addition, an uplink packet may be transmitted from the migrating TAB-MT, and may be transferred to the IAB-donor-CU via the target parent node IAB-DU. The UL packet belongs to an IAB-MT's own signal and, optionally, data traffic. (10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MTs own signalling and, optionally, data traffic.)

In operation 1411, the IAB-donor-CU configures BH RLC channels and BAP-sublayer routing entries in the target path between the target parent IAB-node and target IAB-donor-DU, and DL mapping of the target IAB-donor-DU for the target IAB-donor DU. The target path of the migrating TAB node. The configuration may be performed at the early stage, for example, immediately after operation 1403. The IAB-donor-CU may configure an additional BH RLC channel for the migrating IAB-MT via an RRC message. (11. The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.)

According to an embodiment, in operation 1411, update along a target path may be performed immediately after operation 1403. In case that the MT finally accesses the target cell, the configuration may be transmitted to the migrating node via a UE context mode. However, in the case of CHO, updating along the target path immediately after operation 1403 is unavailable. It is because migration is not actually performed yet, and when the migration is to be performed is not known. Therefore, a configuration of operation 1411 may be provided in advance to the migrating node. However, there is difficulty in updating in advance along the target path.

In operation 1412, the F1-C connection is switched to use the new TNL address of the migrating IAB-node, and the IAB-donor-CU updates the migrating IAB-node on the UL BH information associated with each GTP-tunnel. This operation may also update UL FTEID and DL FTEID related to each GTP tunnel. All F1-U tunnels are switched to use the new TNL address of the migrating IAB node. This operation may use non-UE related signaling in an E1 and/or F1 interface to provide updated UP configurations for F1-U tunnels of multiple connected UEs or child IAB-MTs. The IAB-donor-CU may also update the UL BH information related to non-UP traffic. Implementation needs to avoid a potential competitive condition. That is, configurations that conflict are implemented not to concurrently performed using a UE-related procedure and a non-UE-related procedure. (12. The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions. i.e. no conflicting configurations are concurrently performed using UE-associated and non-UE-associated procedures.)

In operation 1413, the IAB-donor-CU transmits a UE CONTEXT RELEASE COMMAND message to the source parent node IAB-DU. (13. The IAB-donor-CU sends a UE CONTEXT RELEASE COMMAND message to the source parent node IAB-DU.)

In operation 1414, the source parent node IAB-DU releases the context of the migrating IAB-MT and responds to the IAB-donor-CU via a UE CONTEXT RELEASE COMPLETE message. (14. The source parent node IAB-DU releases the migrating IAB-MT's context and responds to the IAB-donor-CU with a UE CONTEXT RELEASE COMPLETE message.)

In operation 1415, the IAB-donor-CU releases BH RLC channels and BAP-sublayer routing entries in the source path between the source parent IAB-node and the source IAB-donor-DU. (15. The IAB-donor-CU releases BH RLC channels and BAP-sublayer routing entries on the source path between source parent IAB-node and source IAB-donor-DU.)

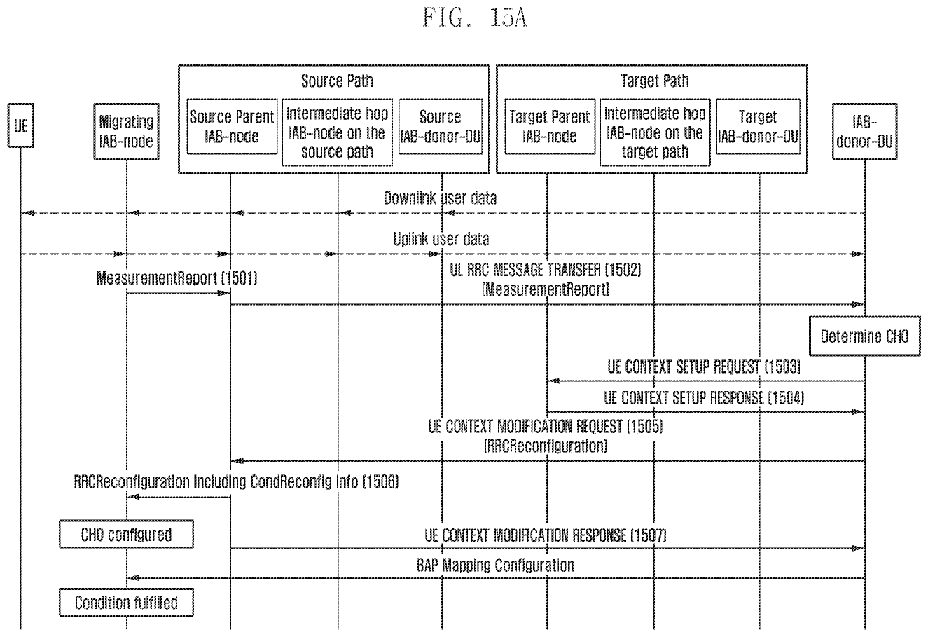

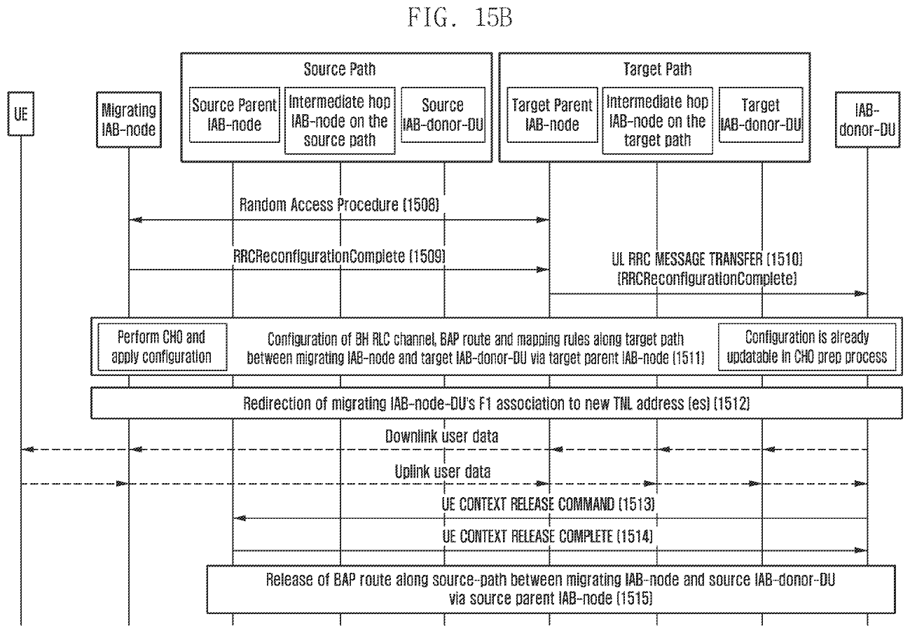

FIGS. 15A and 15B are diagrams illustrating a process of transferring DU and BAP configuration information via an F1AP signal in the case in which conditional handover is applied to IAB migration in a wireless communication system according to an embodiment of the disclosure.

In the embodiments of FIG. 15A and FIG. 15B, DU/BAP configuration is performed via an F1AP together with a reference for a CHO configuration.

In operation 1501, a migrating IAB-MT transmits a MeasurementReport message to a source parent node IAB-DU. The MeasurementReport is based on a measurement configuration that a migrating IAB-MT receives in advance from an IAB-donor-CU. (1. migrating IAB-MT sends a MeasurementReport message to the source parent node IAB-DU. This report is based on a Measurement Configuration the migrating IAB-MT received from the IAB-donor-CU before.)

In operation 1502, a source parent node IAB-DU transmits an UL RRC MESSAGE TRANSFER message to the IAB-donor-CU, so as to transfer the received MeasurementReport. (2. The source parent node IAB-DU sends an UL RRC MESSAGE TRANSFER message to the IAB-donor-CU to convey the received MeasurementReport.)

In operation 1502-1, the IAB donor CU may determine conditional handover based on the given measurementReport. In this process, a target parent TAB node that operates a target cell may be determined.

In operation 1503, the IAB-donor-CU transmits a UE CONTEXT SETUP REQUEST message to a target parent node IAB-DU in order to produce UE context for the migration IAB-MT, and to configure one or more bearers. The bearers may be used by the migrating IAB-MT for its own signal, and, optionally, data traffic. (3. The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.)

In operation 1503-1, the UE CONTEXT SETUP REQUEST message may include a conditional handover indicator.

In operation 1504, a target parent node IAB-DU responds to the IAB-donor-CU via a UE CONTEXT SETUP RESPONSE message. (4. The target parent node IAB-DU responds to the IAB-donor-CU with a UE CONTEXT SETUP RESPONSE message.)

In operation 1505, the IAB-donor-CU transmits a UE CONTEXT MODIFICATION REQUEST message including a produced RRCReconfiguration message to the source parent node IAB-DU. In case that an IPsec tunnel mode is used to protect the F1 and non-F1 traffic, an allocated TNL address is an external IP address. In case that a source path and a target path use the same IAB-donor-DU, the TNL address may not need to be changed. A transmission action indicator of the UE CONTEXT MODIFICATION REQUEST message indicates stop of data transmission to the migrating IAB-node. (5. The IAB-donor-CU sends a UE CONTEXT MODIFICATION REQUEST message to the source parent node IAB-DU, which includes a generated RRCReconfiguration message. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.)

In operation 1505-1, information associated with a condition for performing conditional handover to the target cell in the target parent IAB node may be additionally included in the RRCReconfiguration message, and configuration information to be applied in the corresponding target cell may be included. As the configuration information, the RRCReconfiguration message provided in an octet string may include a default BH RLC channel and a default BAP routing ID configuration for UL F1-C/non-F1 traffic mapping in the target path. An additional BH RLC channel may be included. This operation may also include allocation of a TNL address(es) routable via a target IAB-donor-DU. The new TNL address(es) may be included in the RRCReconfiguration message as a replacement for the TNL address(es) routable via a source IAB-donor-DU. (RRCReconfiguration message as an octet string includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU.)

The IAB donor CU (in the case of intra-donor migration) or the target IAB donor CU (in the case of inter-donor migration) configures the RRCReconfiguration message mentioned in operation 1505-1 and transmits the same in operation 1505, and then, may access a conditional handover target cell by using topology information of the target parent IAb node, and may transfer information needed for DU and BAP configuration to the migrating IAB node via a separate F1-AP message in operation 1505-2. The information may include BAP/DU configuration information, a conditional configuration id of conditional handover given in the current RRC or target cell id information, which is associated with the BAP/DU configuration information. The DU of the migrating IAB node may distinguish the BAP/DU configuration information for each target cell or for each conditional handover configuration id, and may store the same.

The information included in the BAP/DU configuration may include DU configuration and BAP config information, and IAB UP configuration information.

The BAP configuration information may be information associated with BH RLC channels and BAP-sublayer routing entries on the target path, and may be information included in a BAP mapping configuration message in an F1-AP signal.

The IAB UP configuration information may be parameters including UL mapping configuration and the UL/DL UP TNL information, and may be information included in an TAB UP Configuration Update message in an F1-AP signal.

The DU configuration information may be information included in a gNB-DU Resource Configuration message in an F1-AP.

The donor CU may need to synchronize conditional handover configuration information in RRC and DU/BAP configuration information associated with the corresponding target cell. That is, in case that a predetermined conditional handover configuration is added/modified/removed by using an RRC message, related DU/BAP configuration information may be added/modified/removed equally via an F1-AP message.

In operation 1506, the source parent node IAB-DU transfers the received RRCReconfiguration message to the migrating TAB-MT. (6. The source parent node IAB-DU forwards the received RRCReconfiguration message to the migrating IAB-MT.)

RRCReconfiguration includes CondReconfig information. A default BH RLC channel and a default BAP routing ID configuration (which may be an additional BH RLC channel) for UL F1-C/non-F1 traffic mapping in the target path, and the TNL address(es) routable via the target IAB-donor-DU may be included in the RRCReconfiguration message. The new TNL address, instead of the TNL address, may be included in the RRCReconfiguration message. Routing may be performed via the (es) source IAB-donor-DU. The DU may configure a preconfiguration of RRC information (i.e., genuine CHO) and DU predetermined information (a BH RLC channel, a BAP path, and a mapping rule in a migrating IAB node). This is not for updating all configurations along the target path.

After CHO configuration, F1AP configuration information associated with the corresponding candidate target cell may be transferred via an F1AP message. At the time at which a CHO condition is satisfied or at the time at which HO to the corresponding cell is completed, the migrating IAB node may transfer condReconfiglD related to the corresponding original cell to the DU.

In operation 1506-1, the RRCReconfiguration message may include a condition for conditional handover and configuration information, and the configuration information may be an RRCReconfiguration message in the form of an octet string that has been described in operation 1505-1. The migrating TAB node that receives the information may store the conditional handover condition and configuration information, and may start evaluating a condition. In operation 1507, the source parent node IAB-DU responds to the IAB-donor-CU via a UE CONTEXT MODIFICATION RESPONSE message. (7. The source parent node IAB-DU responds to the IAB-donor-CU with the UE CONTEXT MODIFICATION RESPONSE message.)

In operation 1507-1, in case that a given condition is satisfied at any time, the migrating IAB node may apply the configuration and may perform handover to the target parent IAB node corresponding to the condition.

In operation 1507-2, the migrating IAB MT may transfer, to the migrating IAB DU, a conditional configuration id associated with conditional handover to be performed or target cell id information. Specifically, the case in which a condition for the target cell to which handover is to be performed is satisfied, the case in which handover is performed since a condition is satisfied, or the point in time at which handover is performed and RRCReconfigurationComplete is transmitted may be the point in time for transferring. The DU of the migrating TAB node that receives the information may apply DU/BAP configuration information that matches the received conditional configuration id or target cell id.

In operation 1508, a random access procedure is performed in the target parent node IAB-DU. (8. A Random Access procedure is performed at the target parent node IAB-DU.) In operation 1509, the migrating IAB-MT responds to the target parent node IAB-DU via an RRCReconfigurationComplete message. (9. The migrating IAB-MT responds to the target parent node IAB-DU with an RRCReconfigurationComplete message.)

In operation 1510, the target parent node IAB-DU transmits a UL RRC MESSAGE TRANSFER message to the IAB-donor-CU in order to transfer the received RRCReconfigurationComplete message. In addition, an uplink packet may be transmitted from the migrating IAB-MT, and may be transferred to the IAB-donor-CU via the target parent node IAB-DU. The UL packet belongs to the IAB-MT's own signal and, optionally, data traffic. (10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the TAB-donor-CU through the target parent node IAB-DU. These UL packets belong to the IAB-MT's own signalling and, optionally, data traffic.)

In operation 1511, the IAB-donor-CU configures BH RLC channels and BAP sublayer routing entries in the target path between the target parent IAB-node and the target IAB-donor-DU, and DL mapping of the target IAB-donor-DU for a target of the migrating IAB-node. The configuration may be performed at the early stage, for example, immediately after operation 1503. The IAB-donor-CU may configure an additional BH RLC channel for the migrating IAB-MT via an RRC message. (11. The IAB-donor-CU configures BH RLC channels and BAP-sublayer routing entries on the target path between the target parent IAB-node and target TAB-donor-DU as well as DL mappings on the target TAB-donor-DU for the migrating JAB-node's target path. These configurations may be performed at an earlier stage, e.g. immediately after step 3. The IAB-donor-CU may establish additional BH RLC channels to the migrating IAB-MT via RRC message.)

According to an embodiment, in operation 1511, update along the target path may be performed immediately after operation 1503. In case that the MT finally accesses the target cell, the configuration may be transmitted to the migrating node via a UE context mode. However, in the case of CHO, updating along the target path immediately after operation 1503 is unavailable. It is because migration is not actually performed yet, and when the migration is to be performed is not known. Therefore, a configuration of operation 1511 may be provided in advance to the migrating node. However, there is difficulty in updating in advance along the target path. In operation 1512, the F1-C connection is switched to use the new TNL address of the migrating IAB-node, and the IAB-donor-CU updates the migrating IAB-node on the UL BH information associated with each GTP-tunnel. This operation may also update UL FTEID and DL FTEID related to each GTP tunnel. All F1-U tunnels are switched to use the new TNL address of the migrating IAB node. This operation may use non-UE related signaling in an E1 and/or F1 interface and may provide updated UP configurations for the F1-U tunnels of multiple connected UEs or child IAB-MTs. The IAB-donor-CU may also update the UL BH information related to non-UP traffic. Implementation needs to avoid a potential competitive condition. That is, configurations that conflict are implemented not to concurrently performed using a UE-related procedure and a non-UE-related procedure. (12.

The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.)

In operation 1513, the TAB-donor-CU transmits a UE CONTEXT RELEASE COMMAND message to the source parent node IAB-DU. (13. The IAB-donor-CU sends a UE CONTEXT RELEASE COMMAND message to the source parent node IAB-DU.) In operation 1514, the source parent node IAB-DU releases the context of the migrating IAB-MT and responds to the IAB-donor-CU via a UE CONTEXT RELEASE COMPLETE message. (14. The source parent node IAB-DU releases the migrating IAB-MT's context and responds to the IAB-donor-CU with a UE CONTEXT RELEASE COMPLETE message.) In operation 1515, the IAB-donor-CU releases BH RLC channels and BAP-sublayer routing entries in the source path between the source parent IAB-node and the source IAB-donor-DU. (15. The IAB-donor-CU releases BH RLC channels and BAP-sublayer routing entries on the source path between source parent IAB-node and source IAB-donor-DU.)

According to another embodiment, the BAP/DU configuration information may be given for general handover, irrespective of conditional handover of the migrating IAB TM. In this instance, a single target cell, as opposed to multiple cells, is determined as a target cell. Accordingly, in the embodiment of FIG. 14 or FIG. 15, BAP/DU configuration information may be transmitted in advance via an RRC signal (the example of FIG. 14) from a donor CU or via an F1-AP signal (the embodiment of FIG. 15). In this instance, association with a conditional configuration id or a target cell id is not needed.

Particularly, in the embodiment of FIG. 14, in case that BAP/DU configuration information included in RRCReconfiguration is provided to the migrating IAB MT, and the IAB MT performs handover or transmits RRCReconfigurationComplete, the corresponding BAP/DU configuration information may be transferred to a DU. In this instance, the DU may apply the received configuration information.

In the embodiment of FIG. 15, the Bap/DU configuration information provided via an F1-AP may be provided to the DU without separate association with a conditional configuration id or target cell id, and in case that the migrating IAB MT performs handover or transmits RRCReconfigurationComplete, the DU may be informed of the same via a separate indicator. In this instance, the DU may apply the corresponding configuration.

Another example is the case in which a child node is connected to the migrating IAB node. In this instance, not only a BAP/DU but also application of an RRCReconfiguration message including the same is taken into consideration. There may be the case in which the DU/BAP configuration information and the RRCReconfiguration message including the same is transmitted via an RRC signal to the IAB node MT that is to directly apply the same, and the case in which the transmission is performed via an F1-AP to a parent node of the IAB node that is to directly apply the same. In the case of direct application using RRC, RRCReconfiguration may be applied when a separate indicator is received from the parent node. Conversely, in case that the F1-AP is used, a child node may apply received RRCReconfiguration at the point in time at which the parent node transfers the RRCReconfiguration message to the child node.

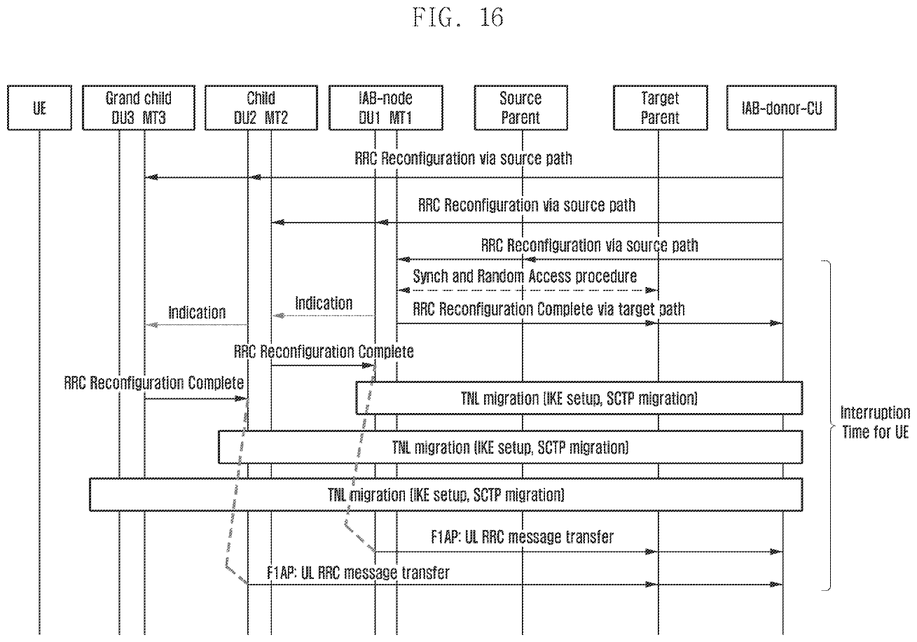

FIG. 16 is a diagram illustrating a process of transferring RRCReconfiguration via an RRC signal in a wireless communication system according to an embodiment of the disclosure.

Referring to FIG. 16, in case that signaling is performed by using an RRC signal, a donor CU determines migration, obtains configuration information of a corresponding target cell (operation 1404 in the embodiment of FIG. 14 or operation 1504 in the embodiment of FIG. 15), and then transfers BAP/DU configuration information to a child node of a migrating IAB node first via an RRC message. After transferring the configuration to all descendant IAB nodes (i.e., all child/grandchild IAB nodes or the like subordinate to the migrating IAB node), the donor CU may transfer a handover command, that is, RRCReconfiguration, to the migrating IAB node. According to the message, the migrating IAB node may perform handover, and may transmit an RRCReconfigurationComplete message to a target parent node.

In case that the migrating IAB node applies the received RRCReconfiguration, in case that the migrating IAB node performs handover, in case that the migrating IAB node performs synchronization and random access, in case that the migrating TAB node transmits an RRCReconfigurationComplete message, or in case that handover of the migrating IAB node is successfully completed, the migrating TAB node may transfer a separate indicator to a child node of the migrating IAB node. The child IAB node that receives the indicator applies the RRCReconfiguration received in advance, and may apply the BAP/DU configuration included in the RRCReconfiguration. In response thereto, an RRCReconfigurationComplete message is transferred to the parent node of the child node, that is, the node that transfers the indication. The indicator may be a BAP control PDU, or may be a MAC CE or a physical layer DCI.

From the perspective of an TAB node, in case that the received RRCReconfiguration message includes the BAP/DU configuration information or a separate indicator indicating delayed RRCReconfiguration, the RRCReconfiguration is not applied immediately after reception, but the received RRCReconfiguration is applied and BAP/DU configuration included therein is also applied in case that the indication is received from the parent node. In case that the RRCReconfiguration configuration is applied and its own child node is present, the same indication may be transmitted to the child node. In case that the migrating TAB node performs conditional handover, the BAP/DU configuration and RRCReconfiguration including the same that each descendant TAB node receives from a donor node may be associated with a conditional configuration id of conditional handover or a target cell id, and the indicator may include the conditional configuration id or the target cell id. The IAB node that receives the indicator including the conditional configuration id or the target cell id may apply configuration information associated with the conditional configuration id or target cell id among RRCReconfiguration and BAP/DU configuration information that the IAB node stores.

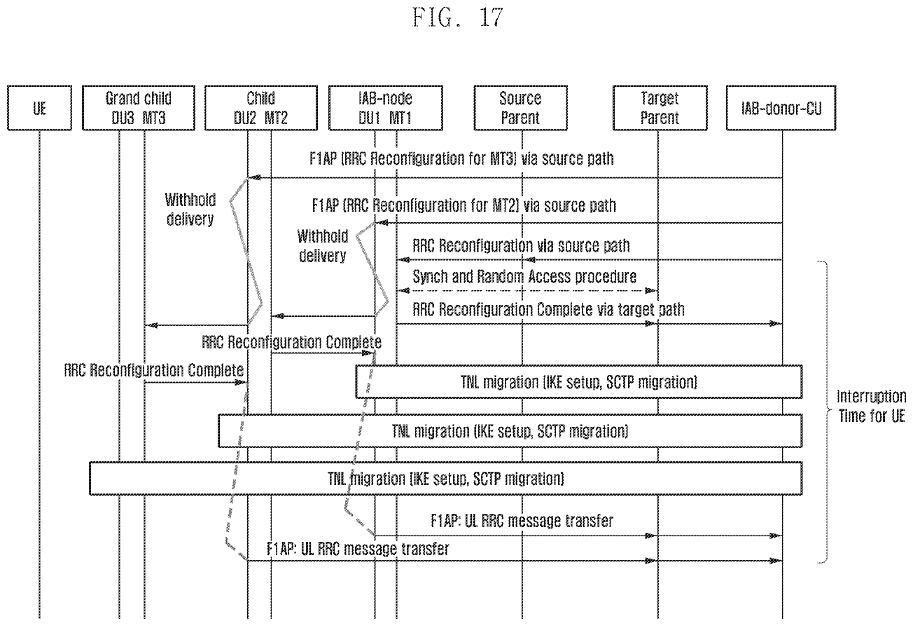

FIG. 17 is a diagram illustrating a process of transferring RRCReconfiguration via an F1-AP in a wireless communication system according to an embodiment of the disclosure.

Referring to FIG. 17, in case that signaling is performed by using an F1-AP, a donor CU determines migration, obtains configuration information of a corresponding target cell (operation 1404 in the embodiment of FIG. 14 or operation 1504 in the embodiment of FIG. 15), and then transfers an RRCReconfiguration message including BAP/DU configuration information to a parent node of a child node of a migrating IAB node first via an F1-AP message. The message may be stored in a DU part of the IAB node that performs reception. After the parent IAB node of all descendant TAB nodes (i.e., all child/grandchild IAB nodes or the like subordinate to the migrating IAB node) receives the message, the donor CU may transfer a handover command, that is, RRCReconfiguration, to the migrating IAB node. According to the message, the migrating IAB node may perform handover, and may transmit an RRCReconfigurationComplete message to a target parent node.

In case that the migrating TAB node applies the received RRCReconfiguration, in case that the migrating IAB node performs handover, in case that the migrating IAB node performs synchronization and random access, in case that the migrating IAB node transmits an RRCReconfigurationComplete message, or in case that handover of the migrating TAB node is successfully completed, the migrating IAB node may transfer, to a child node of the migrating IAB node, the RRCReconfiguration message that the migrating IAB node receives and stores in the DU part. The child IAB node that receives the message applies the RRCReconfiguration received in advance, and may apply BAP/DU configuration included in the RRCReconfiguration. In response thereto, an RRCReconfigurationComplete message is transferred to its parent node, that is, the node that transfers the RRCReconfiguration.

From the perspective of the IAB node, in case that an indicator indicating delay delivery of an RRCReconfiguration message is included in the F1-AP message, the DU of the corresponding IAB node may not transmit the RRCReconfiguration to its child node immediately after reception of the F1-AP message, but may store the same and transmit the RRCReconfiguration to its child node at the point in time at which the IAB node receives RRCReconfiguration from its parent IAB node and applies the same. In case that the migrating IAB node performs conditional handover, the BAP/DU configuration and RRCReconfiguration including the same which the parent node of all descendant IAB nodes receives may be associated with a conditional configuration id of conditional handover or a target cell id, and in case that the migrating TAB node performs conditional handover, the conditional configuration id or the target cell id information of the target may be transferred to each child node via RRCReconfiguration. Based on the information, the IAB node that receives the message may also transfer, to its child node, an RRCReconfiguration message including conditional configuration id or target cell id information.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

1. A method performed by a base station of a communication system, the method comprising:
receiving, from a donor base station, an indicator and a radio resource control (RRC) reconfiguration message including configuration information for at least one child node of the base station, wherein the indicator indicates, to the base station, withholding of the RRC reconfiguration message until a predetermined condition is met;
withholding the RRC reconfiguration message until the predetermined condition is met; and
transmitting the RRC reconfiguration message to the at least one child node in case that the predetermined condition is met.

2. The method of claim 1, wherein the predetermined condition comprises at least one of a random access procedure is successfully completed in case that the base station is a migrating node, or a mobile termination (MT) of the base station receives the RRC reconfiguration message from a parent node in case that the base station is a child node of the migrating node.

3. The method of claim 1, wherein the configuration information comprises at least one of a transport network layer (TNL) address or routing mapping information.

4. The method of claim 1, wherein the base station is an integrated access and backhaul (IAB) node.

5. A method performed by a donor base station of a communication system, the method comprising:
transmitting, to a child node, an indicator and a radio resource control (RRC) reconfiguration message including configuration information for at least one grandchild node of the child node of the donor base station, wherein the indicator indicates, to the child node, withholding of the RRC reconfiguration message until a predetermined condition is met; and
performing data transmission or reception with the child node and the at least one grandchild node based on the configuration information,
wherein, in case that the predetermined condition is met, the RRC reconfiguration message is transmitted from the child node to the at least one grandchild node.

6. The method of claim 5, wherein the predetermined condition comprises at least one of a random access procedure is successfully completed in case that the child node is a migrating node, or a mobile termination (MT) of the child node receives the RRC reconfiguration message from a parent node in case that the child node is a child node of the migrating node.

7. The method of claim 5, wherein the configuration information comprises at least one of a transport network layer (TNL) address or routing mapping information.

8. The method of claim 5, wherein the child node is an integrated access and backhaul (IAB) node.

9. A base station of a communication system, the base station comprising:
a transceiver; and
a controller coupled with the transceiver, and configured to receive, from a donor base station, an indicator and a radio resource control (RRC) reconfiguration message including configuration information for at least one child node of the base station, the indicator indicating, to the base station, withholding of the RRC reconfiguration message until a predetermined condition is met, withholding the RRC reconfiguration message until the predetermined condition is met, and transmit the RRC reconfiguration message to the at least one child node in case that the predetermined condition is met.

10. The base station of claim 9, wherein the predetermined condition comprises at least one of a random access procedure is successfully completed in case that the base station is a migrating node, or a mobile termination (MT) of the base station receives the RRC reconfiguration message from a parent node in case that the base station is a child node of the migrating node.

11. The base station of claim 9, wherein the configuration information comprises at least one of a transport network layer (TNL) address or routing mapping information.

12. The base station of claim 9, wherein the base station is an integrated access and backhaul (IAB) node.

13. A donor base station of a communication system, the donor base station comprising:
a transceiver; and
a controller coupled with the transceiver, and configured to transmit, to a child node, an indicator and a radio resource control (RRC) reconfiguration message including configuration information for at least one grandchild node of the child node of the donor base station, the indicator indicating, to the child node, withholding of the RRC reconfiguration message until a predetermined condition is met, and perform, based on the configuration information, data transmission or reception with the child node and the at least one grandchild node,
wherein, in case that the predetermined condition is met, the RRC reconfiguration message is transmitted from the child node to the at least one grandchild node.

14. The donor base station of claim 13, wherein the predetermined condition comprises at least one of a random access procedure is successfully completed in case that the child node is a migrating node or a mobile termination (MT) of the child node receives the RRC reconfiguration message from a parent node in case that the child node is a child node of the migrating node.

15. The donor base station of claim 13, wherein the configuration information comprises at least one of a transport network layer (TNL) address or routing mapping information.
